(19) United States
(12) Patent Application Publication
(10) Pub. No.: US 2025/0227648 A1
(43) Pub. Date: Jul. 10, 2025

(54) Mobility of Mobile Base Station Relay

(71) Applicant: Ofinno, LLC, Reston, VA (US)

(72) Inventors: SungDuck Chun, Fairfax, VA (US); Kyungmin Park, Vienna, VA (US); Esmael Hejazi Dinan, McLean, VA (US); Jian Xu, McLean, VA (US); Peyman Talebi Fard, Vienna, VA (US); Weihua Qiao, Herndon, VA (US); Stanislav Filin, Chantilly, VA (US)

(73) Assignee: Ofinno, LLC, Reston, VA (US)

(21) Appl. No.: 19/091,220

(22) Filed: Mar. 26, 2025

Related U.S. Application Data
(63) Continuation of application No. PCT/US2023/033626, filed on Sep. 25, 2023.
(60) Provisional application No. 63/410,056, filed on Sep. 26, 2022.

(51) Int. Cl. H04W 60/04; H04W 48/08; H04W 48/18; H04W 92/18

(52) U.S. Cl. CPC H04W 60/04; H04W 48/08; H04W 48/18; H04W 92/18

(57) ABSTRACT

A method can include sending, by a first wireless device to an access and mobility management function (AMF) via a mobile base station relay (MBSR), a registration request message requesting a first network slice and a second network slice. The MBSR can include a base station distributed unit and a mobile terminal unit connecting to a base station central unit via a Uu interface. The MBSR can support mobility within a network and can broadcast an indication of a mobile relay cell. The method can also include receiving, from the MBSR, a registration accept message indicating the first network slice being allowed and the second network slice being rejected. The method can further include receiving, from the MBSR, one or more messages indicating a tracking area change of the MBSR, the second network slice being supported, and the first network slice being rejected.

### CROSS REFERENCE TO RELATED APPLICATIONS

This application is a continuation of International Application No. PCT/US2023/033626, filed Sep. 25, 2023, which claims the benefit of U.S. Provisional Application No. 63/410,056, filed Sep. 26, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 illustrates the concept of wireless device tracking areas (TAs) and the possibility of different supports and/or restrictions among different TAs.

FIG. 16 illustrates an example of integrated access and backhaul (IAB).

FIG. 17 illustrates an example of a mobile base station relay (MBSR).

FIG. 18 illustrates an example of registration of an MBSR and a wireless device.

FIG. 19 illustrates an example of MBSR mobility in accordance with aspects of the disclosure.

FIG. 20 illustrates an example of MBSR mobility in accordance with aspects of the disclosure.

FIG. 21 illustrates an example of MBSR mobility in accordance with aspects of the disclosure.

FIG. 22 illustrates examples of determination, detection, identification, and/or notification of a mobility event.

FIG. 23 illustrates examples of determination, detection, identification, and/or notification of a mobility event.

FIG. 24 illustrates examples of determination, detection, identification, and/or notification of a mobility event.

FIG. 25 illustrates examples of context management in an MBSR scenario.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

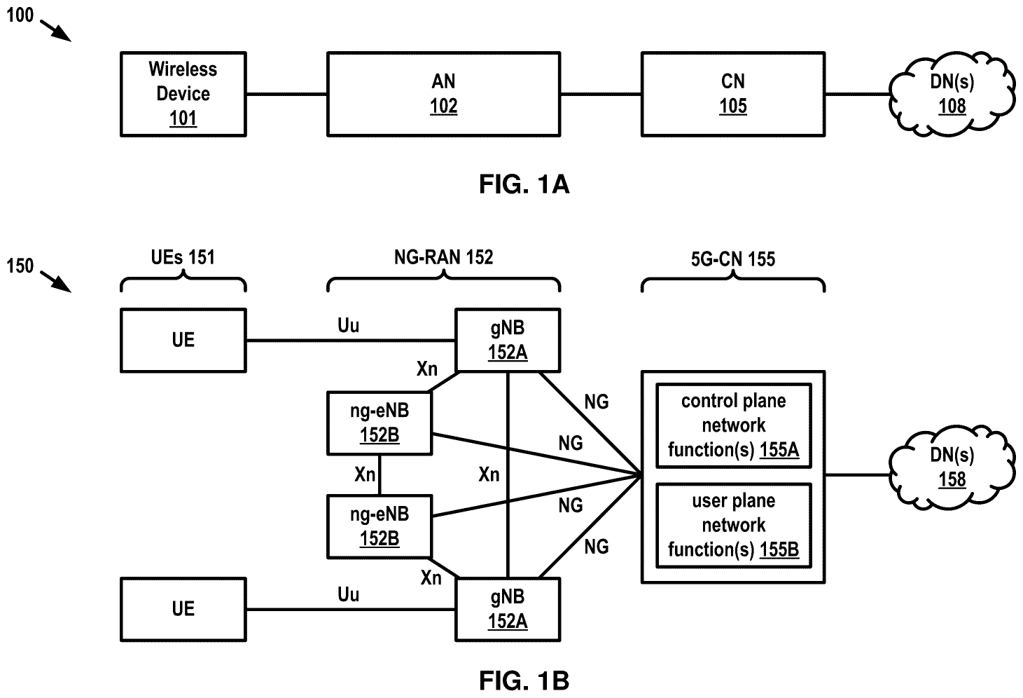

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, Wi-Fi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

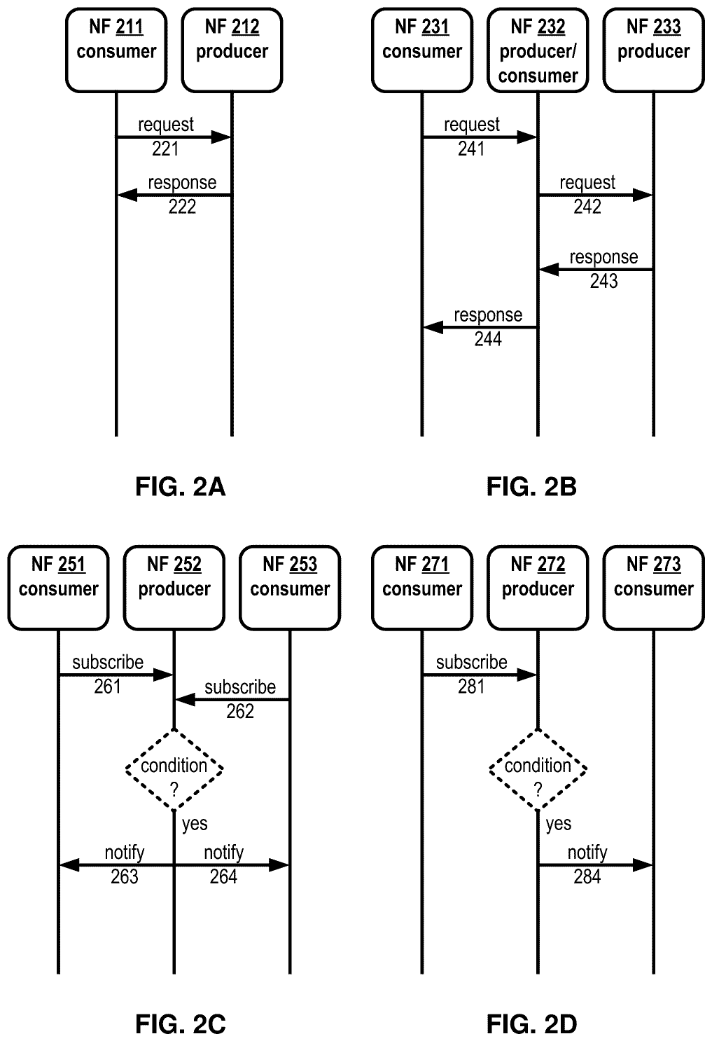

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 231 to an NF 212 (a producer NF). The request 231 may be a request for a particular service and may be sent based on a discovery that NF 212 is a producer of that service. The request 231 may comprise data relating to NF 211 and/or the requested service. The NF 212 may receive request 231, perform one or more actions associated with the requested service (e.g., retrieving data), and provide a response 231. The one or more actions performed by the NF 212 may be based on request data included in the request 231, data stored by NF 212, and/or data retrieved by NF 212. The response 232 may notify NF 211 that the one or more actions have been completed. The response 232 may comprise response data relating to NF 212, the one or more actions, and/or the requested service.

In the example of FIG. 2B, an NF 241 sends a request 221 to an NF 242. In this example, part of the service produced by NF 242 is to send a request 222 to an NF 243. The NF 243 may perform one or more actions and provide a response 223 to NF 242. Based on response 223, NF 242 may send a response 224 to NF 241. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

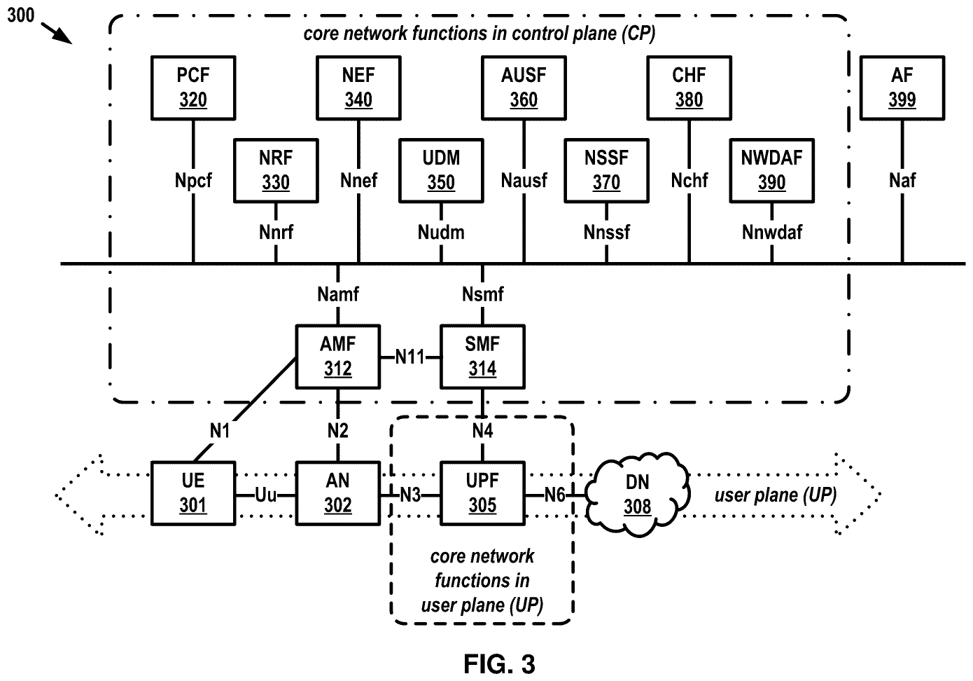

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

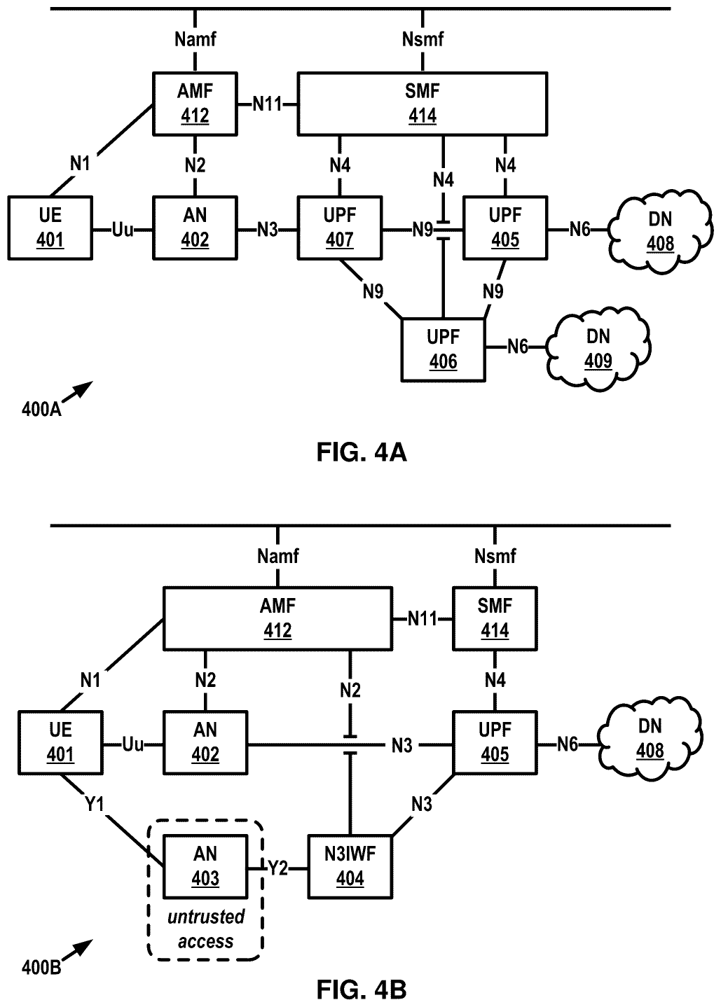

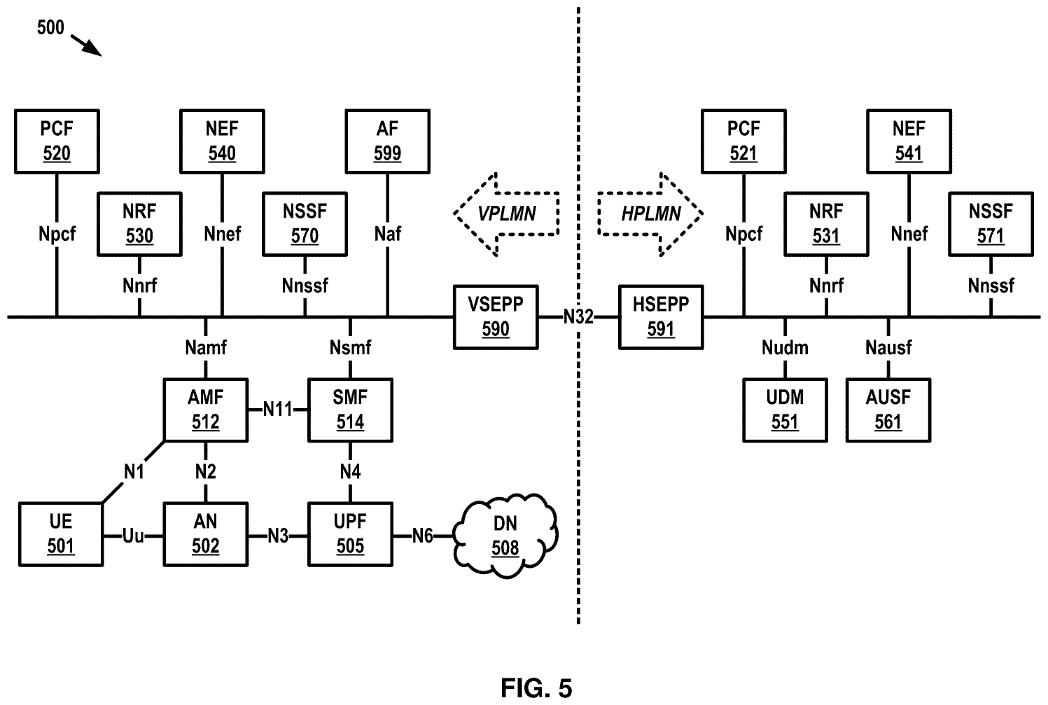

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

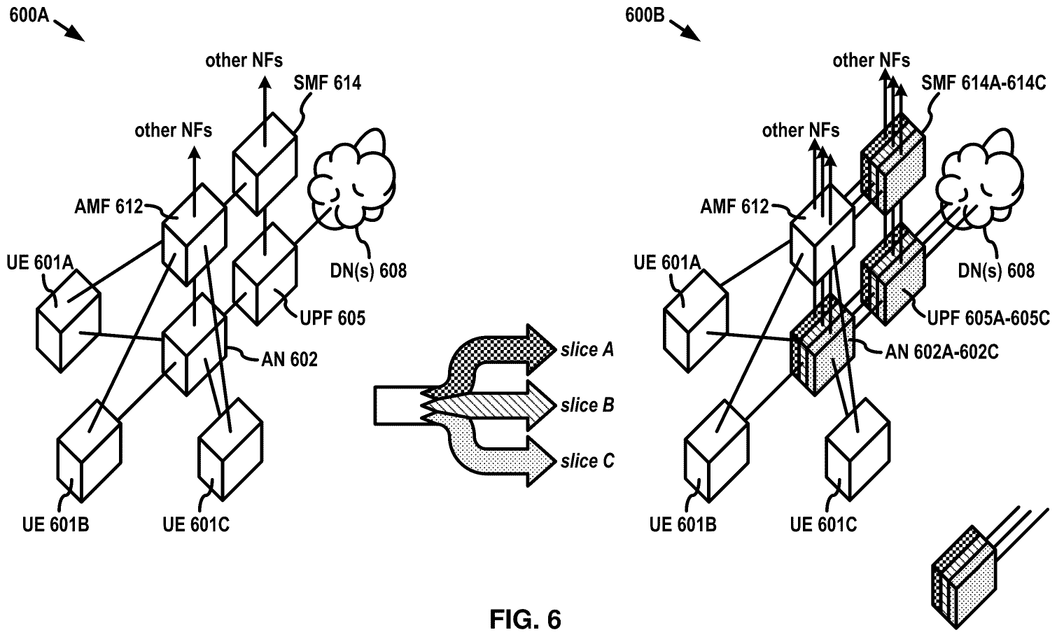

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, sliceA may correspond to enhanced mobile broadband (eMBB) service. Mobile broadband may refer to internet access by mobile users, commonly associated with smartphones. SliceB may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacturer, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

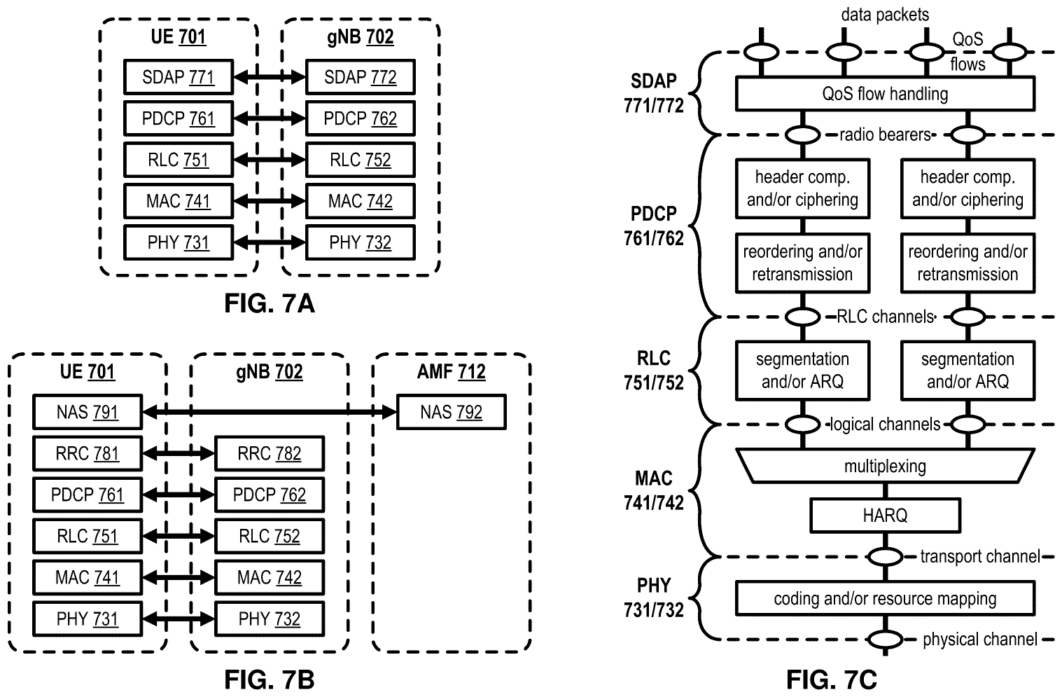

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 230 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 233 may provide RLC channels as a service to PDCPs 214 and 234, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

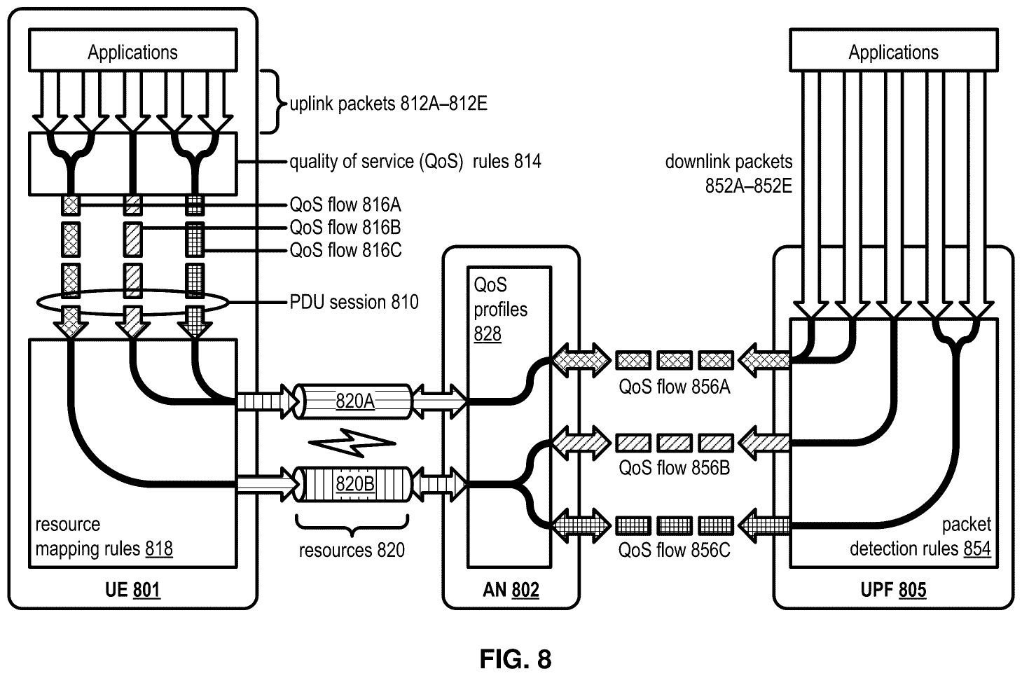

FIG. 8 illustrates an example of a quality of service (QoS) model for differentiated data exchange. In the QoS model of FIG. 8, there are a UE 801, an AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

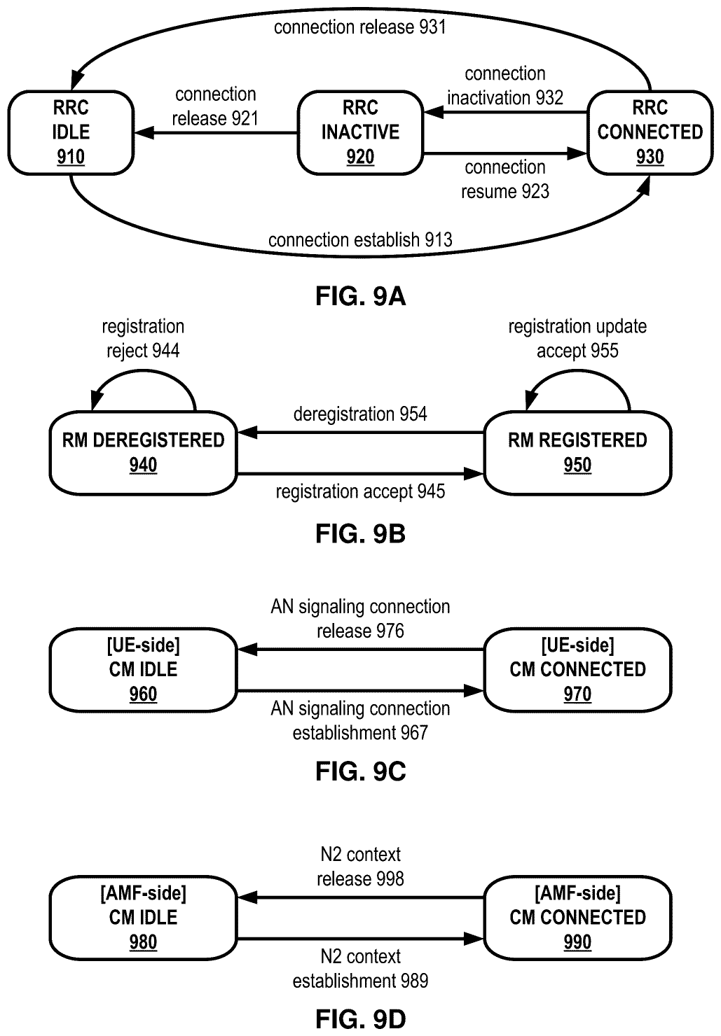

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and, if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non-access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF may establish an N2 context of the UE (N2 context establishment 989). When the UE transitions from CM connected 990 to CM idle 980, the AMF may release the N2 context of the UE (N2 context release 998).

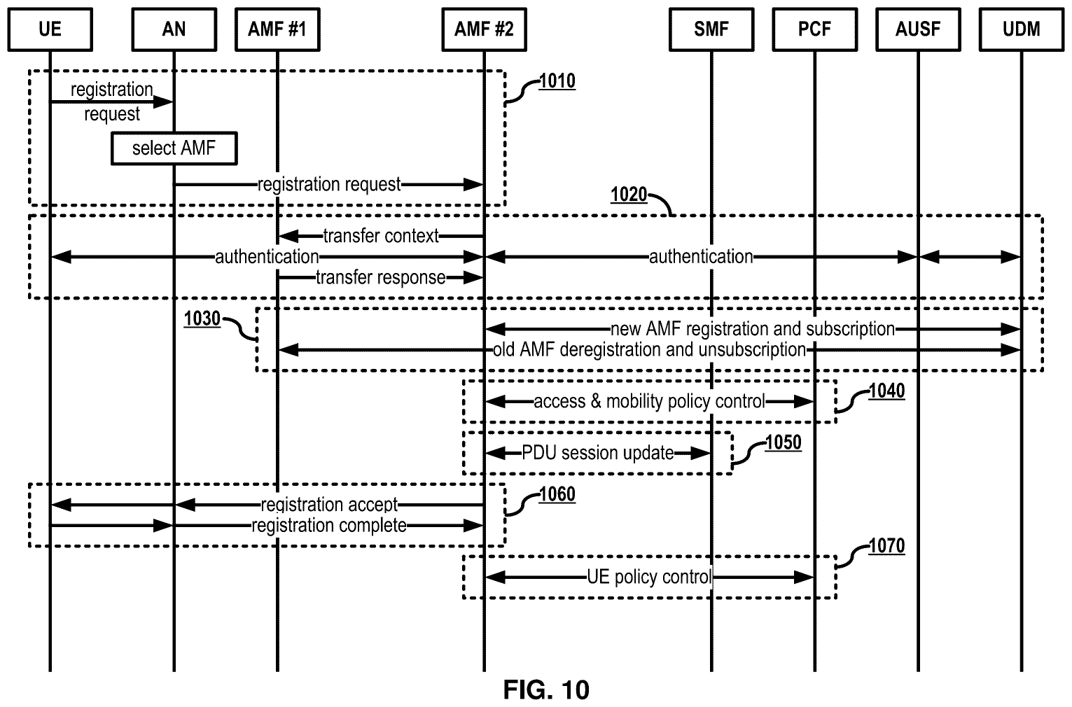

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

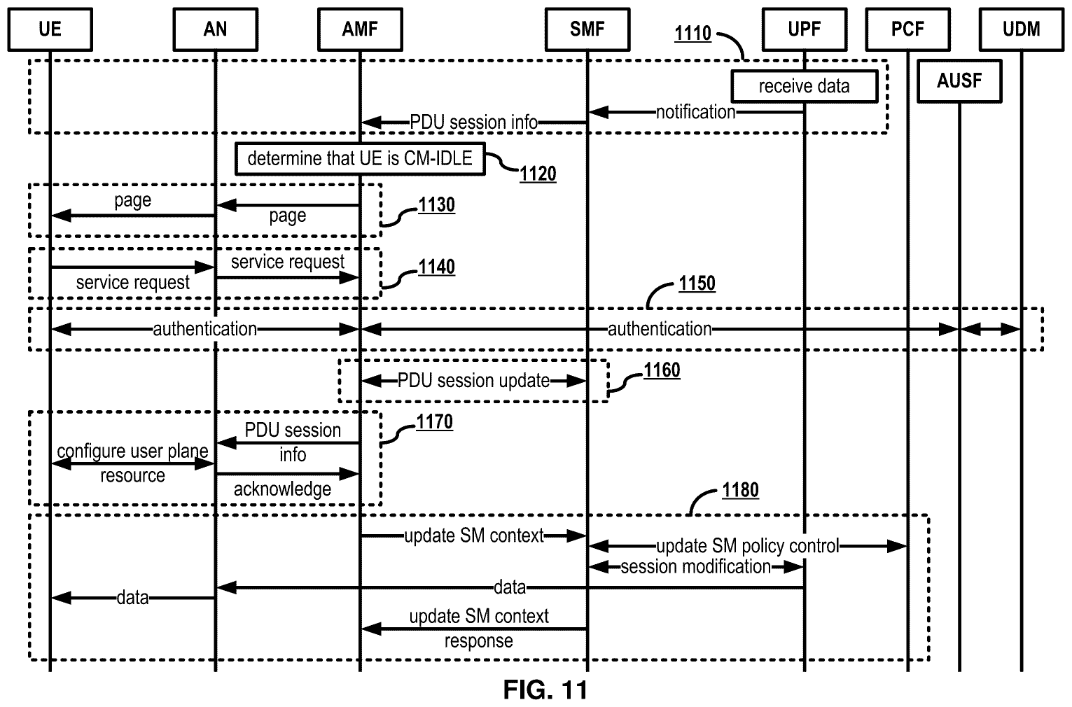

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

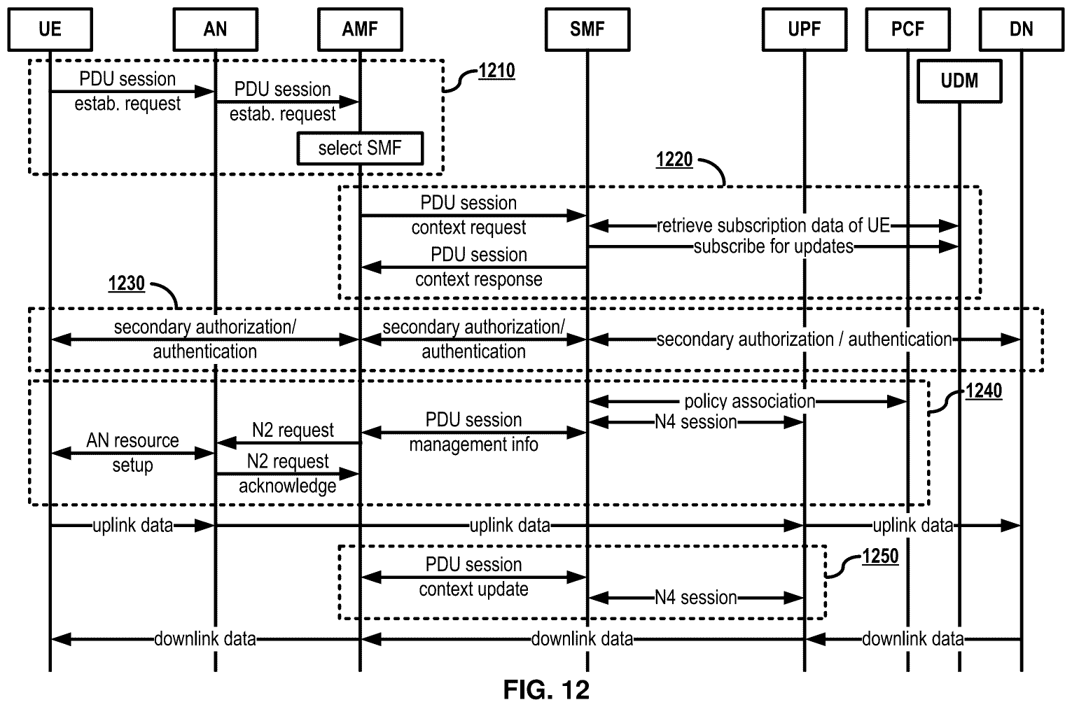

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU Session Establishment accept message. The PDU Session Establishment accept message may include tunneling endpoint information of the UPF and quality of service (QoS) information associated with the PDU session.

The AMF may send an N2 request to the AN. The N2 request may include the PDU Session Establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU Session Establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

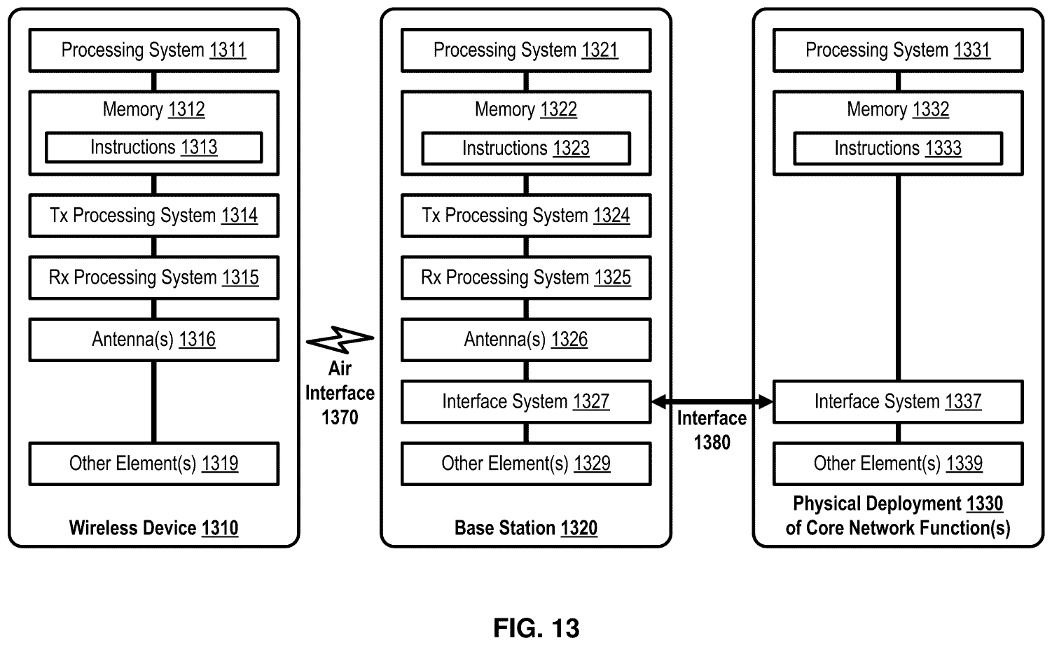

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

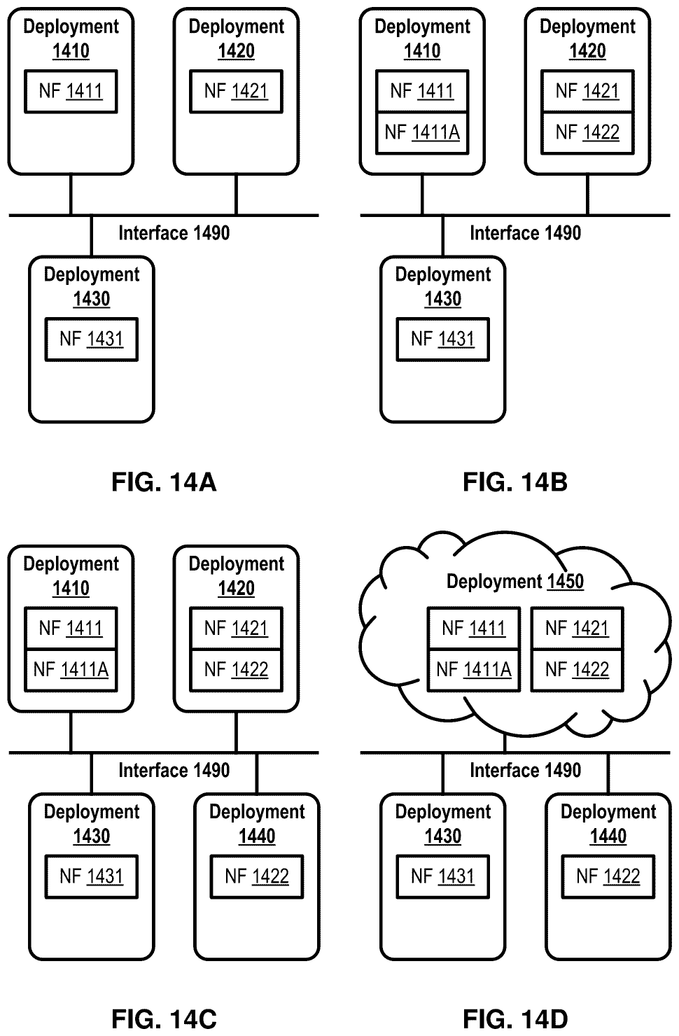

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

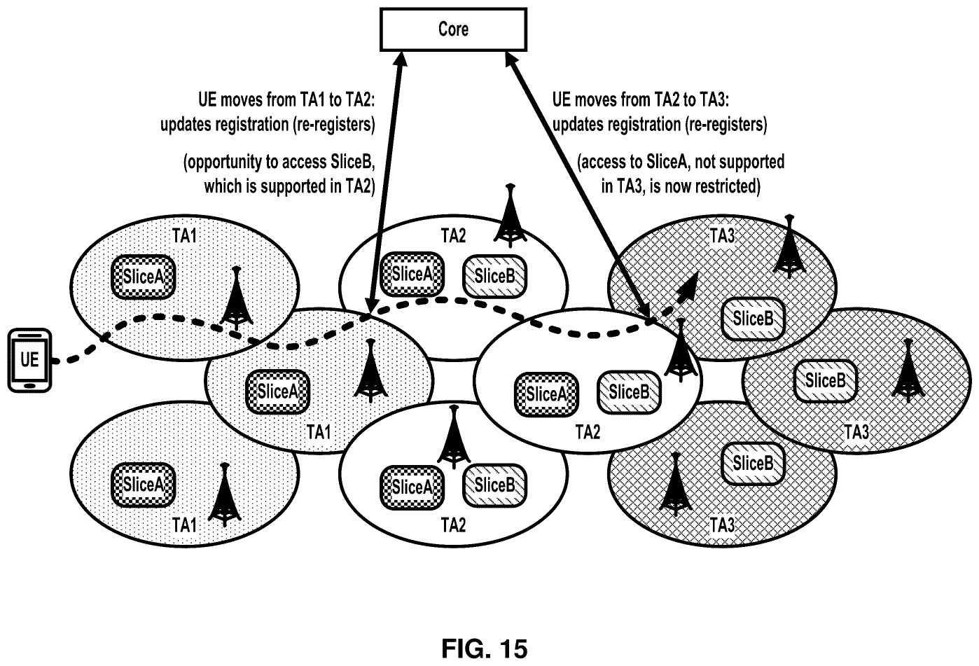

FIG. 15 illustrates the concept of wireless device tracking areas (TAs) and the possibility of different supports and/or restrictions among different TAs.

In the figure, a first tracking area TA1 includes one or more first cells, a second tracking area TA2 includes one or more second cells, and a third tracking area TA3 includes one or more third cells. A wireless device (e.g., UE) moves throughout the TAs.

The TAs in the figure have different restrictions and/or support. For example, the TAs may be associated with allowed/not allowed areas; specific closed subscriber groups (CSGs) and/or closed access groups (CAGs); specific network slices; etc.

In an allowed area, the UE may be allowed to transmit data or signaling with the base station (e.g., via a Uu interface with the base station), whereas in a non-allowed area, data transmission may not be allowed (e.g., only signaling is allowed via the Uu interface). In an example, one TA may be in an allowed area of the UE, whereas another TA may be in a not-allowed area of the UE.

The UE may have a subscription and/or access to a CSG or a CAG. The UE may be permitted to access the network via a particular CSG. The UE may be permitted to access the network via a particular CAG. The UE may not be permitted to access the network except via the particular CAG. In an example, one TA may support access to a particular CAG, whereas another TA does not.

There are many possible examples of supports and/or restrictions that may be specific to a tracking area. Accordingly, as the UE travels through different TAs, supports and/or restrictions may change. As an example of different supports and/or restrictions, the figure illustrates an example of differential support for various network slices, represented as sliceA and sliceB. In particular, TA1 supports sliceA (e.g., does not support sliceB), TA2 supports sliceA and sliceB, and TA3 supports sliceB (e.g., does not support sliceA).

Each cell may transmit (e.g., broadcast) tracking area information. For example, each cell may transmit (e.g., broadcast) a system information block (SIB) comprising at least one of a tracking area code (TAC), a tracking area identifier (TAI), a new radio cell global identifier (NCGI), etc.

A wireless device (e.g., UE) may receive the SIB. The cell may be in TA1, as shown in the figure, and the SIB may indicate (for example) a TAC of TA1. The UE may receive the SIB via the cell and register with the network via the cell. For example, the UE may send a registration request message to a core of the network (e.g., an AMF of the network). In response to the registration request message, the network may send a registration accept message. The registration accept message may indicate various supports and/or restrictions associated with TA1. For example, the network may indicate that sliceA is supported (and/or that sliceB is not supported). Slice support may be common to all cells in TA1. For example, all of the one or more first cells in TA1 may support sliceA (and/or not support sliceB). For example, in the figure, there are three cells associated with TA1. Each cell in TA1 may transmit (e.g., broadcast) SIBs indicating TA1. So long as SIBs indicating TA1 are received by the UE, the UE may recognize that it has not left TA1. So long as the UE has not left TA1, the UE may recognize that support and/or restrictions associated with TA1 (e.g., the network slice supports shown in the figure) have not changed.

The UE may later move into TA2. The UE may receive a SIB from a cell in TA2. The SIB may indicate a TAC of TA2. Based on the SIB indicating a different TAC, the UE may recognize that it has moved into a different tracking area. Based on moving into a different tracking area, the UE may recognize that it has moved into a different registration area. Based on moving into a different registration area, the UE may re-register with the network.

(It will be understood that a registration area may include more than one TA. Accordingly, not every move into a new TA will prompt re-registration with the network. If the new TA is in the same registration area as the old TA, then re-registration may not be necessary. However, in the present example, for simplicity, TA1, TA2, TA3 are understood to be in different registration areas.)

When the UE registers via the cell in TA2, the network (again) indicates supports and/or restrictions associated with the TA. In the present example, the network may indicate to the UE that sliceA and sliceB are supported. Accordingly, the UE may continue to use sliceA (which was supported in TA1), and may now also use sliceB (which had not been supported in TA1).

The UE may continue to use sliceA and sliceB for as long as the UE remains in TA2. However, the UE may later move into TA3. Based on moving into a different registration area, the UE may re-register with the network. In the figure, the network indicates that sliceA is not supported in TA3. Accordingly, the UE can no longer use slice A.

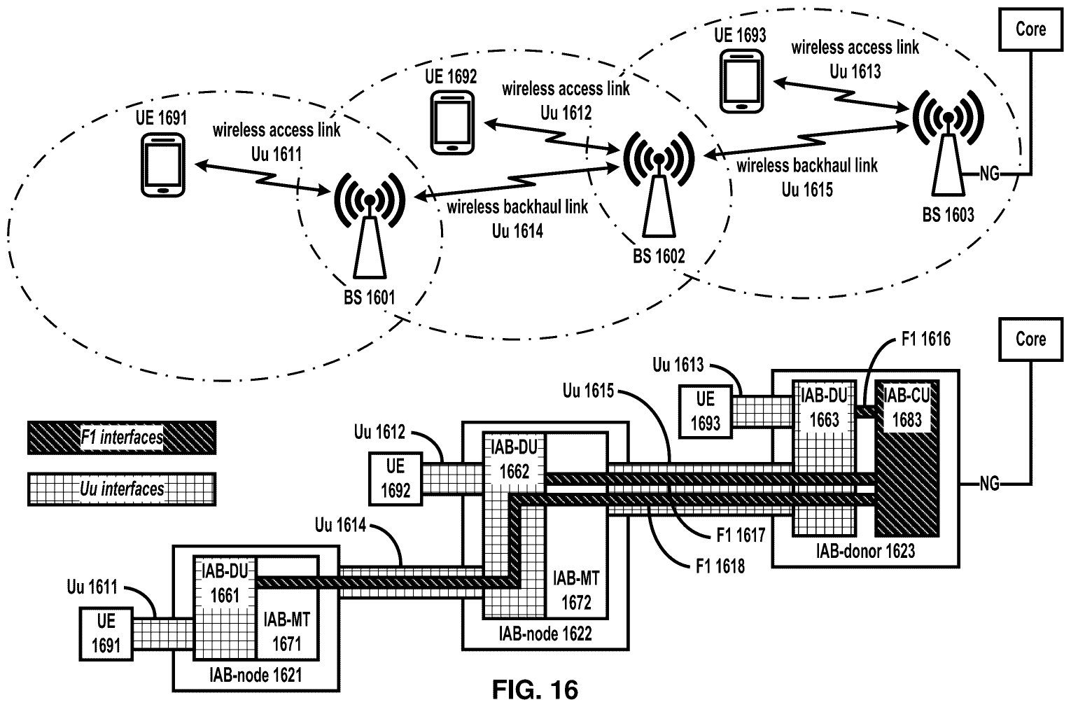

FIG. 16 illustrates an example of integrated access and backhaul (IAB). IAB functionality enables base stations (e.g., gNB, eNB, MeNB, SgNB, etc.) to act as relay nodes (e.g., wireless relay nodes).

In the example figure, several user equipment (UE 1691, UE 1692, UE 1693) access a network via wireless access links of several base stations (BS 1601, BS 1602, BS 1603). Each wireless access link between a UE and a BS may operate as a Uu interface. In particular, the UE 1691 accesses BS 1601 via Uu 1611, UE 1692 accesses the BS 1602 via Uu 1612, and UE 1693 accesses BS 1603 via Uu 1613.

As noted above, IAB functionality enables the BSs 1601-1603 to act as wireless relay nodes. The BSs 1601-1603 may communicate via wireless backhaul links. The wireless backhaul link between BSs may operate as a Uu interface. In particular, BS 1601 has Uu 1614 with BS 1602 and BS 1602 has Uu 1615 with BS 1603.

The BS 1603 has an interface with a core of the network. The interface may be an NG interface (as shown in the figure), an S1-U interface, etc.

In the example figure, BSs 1601-1603 have IAB functionality. At the bottom of the example figure, BS 1601 and BS 1602 are depicted in terms of IAB architecture. In particular, BS 1601 and BS 1602 are depicted as IAB-node 1621 and IAB-node 1622, respectively, and BS 1603 is depicted as IAB-donor 1623.

The IAB-nodes 1621-1622 have distributed unit (DU) functionality. The DU functionality of each IAB-node may be directed downstream (toward the left in the example figure). The DU functionality is illustrated as IAB-DU 1661 and IAB-DU 1662, respectively. The IAB-DUs 1661-1662 use the DU functionality to communicate downstream via a wireless access link (e.g., Uu interface). For example, IAB-node 1621 uses IAB-DU 1661 to communicate downstream to UE 1691 via Uu 1611. IAB-node 1622 uses IAB-DU 1662 to communicate downstream to UE 1692 via Uu 1612. As will be discussed in greater detail below, IAB-node 1622 also uses IAB-DU 1662 to communicate downstream to IAB-node 1621 via Uu 1614.

In addition to DU functionality (for communicating downstream in an IAB context, e.g., with one or more child nodes), each IAB-node may have mobile terminal (MT) functionality (for communicating upstream, e.g., with one or more parent nodes, or IAB-donor). The MT functionalities are illustrated as IAB-MT 1671 and IAB-MT 1672, respectively. The IAB-MTs 1671-1672 use the MT functionality to communicate upstream via a Uu interface. For example, IAB-node 1621 uses IAB-MT 1671 to communicate upstream to IAB-node 1622 via Uu 1614. IAB-node 1622 uses IAB-MT 1672 to communicate upstream to IAB-donor 1623 via Uu 1615.

The IAB-donor 1623 has central unit (CU) functionality. The CU functionality is illustrated as IAB-CU 1683. The IAB-donor 1623 uses the CU functionality to communicate upstream with the core of the network (e.g., via an NG interface, S1-U interface, etc.). Similar to the IAB-nodes 1621-1622, the IAB-donor 1623 may have DU functionality, illustrated as IAB-DU 1663. Similar to the IAB-nodes 1621-1622, the IAB-donor 1623 uses the DU functionality to communicate downstream via a Uu interface. For example, IAB-donor 1623 uses IAB-DU 1663 to communicate downstream to UE 1693 via Uu 1613. IAB-donor 1623 also uses IAB-DU 1663 to communicate downstream to IAB-node 1622 via Uu 1615.

From the perspective of the IAB-CU 1683 of the IAB-donor 1623, the IAB-node 1621 and IAB-node 1622 may be regarded as distributed units, similar to IAB-DU 1663. For example, BS 1603 may operate as a base station central unit with F1 interfaces to several base station distributed units. An F1 interface 1616 may be implemented within BS 1603 between IAB-CU 1683 and IAB-DU 1663. Another base station distributed unit may be implemented as DU functionality within BS 1602. An F1 interface 1617 may be implemented between IAB-CU 1683 and IAB-DU 1662, employing the wireless backhaul link Uu 1615. Yet another base station distributed unit may be implemented as DU functionality within BS 1601. An F1 interface 1618 may be implemented between IAB-CU 1683 and IAB-DU 1661, employing the series of wireless backhaul links Uu 1614-1615. It will be understood that a ‘multi-hop’ F1 interface may be implemented across any number of wireless backhaul links. In this manner, base stations configured with IAB functionality may act as IAB-nodes, enabling the base stations to act as communication relays.

In light of the foregoing example, it will be understood that IAB enables wireless relaying in NG-RAN. The relaying node, referred to as IAB-node, supports access and backhauling via 3GPP new radio (NR). The terminating node of NR backhauling on the network side may be referred to as the IAB-donor, which represents a base station (e.g., gNB) with additional functionality to support IAB. Backhauling can occur via a single hop or via multiple hops.

The IAB-node supports the gNB-DU functionality to terminate the NR access interface to UEs and next-hop IAB-nodes, and to terminate the F1 protocol to the gNB-CU functionality, on the IAB-donor. The gNB-DU functionality on the IAB-node may be referred to as IAB-DU.

In addition to the gNB-DU functionality, the IAB-node also supports a subset of the UE functionality referred to as IAB-MT, which includes, e.g., physical layer, layer-2, radio resource control (RRC) and non-access stratum (NAS) functionality to connect to the DU functionality of another IAB-node or the IAB-donor; to connect to the gNB-CU on the IAB-donor; and to connect to the core network.

In 4G systems, the IAB-node can access the network using standalone architecture (SA mode) or E-UTRA-NR dual connectivity (EN-DC). In EN-DC, the IAB-node connects via E-UTRA to a master eNB (MeNB), and the IAB-donor terminates an X2-C interface as a secondary gNB (SgNB).

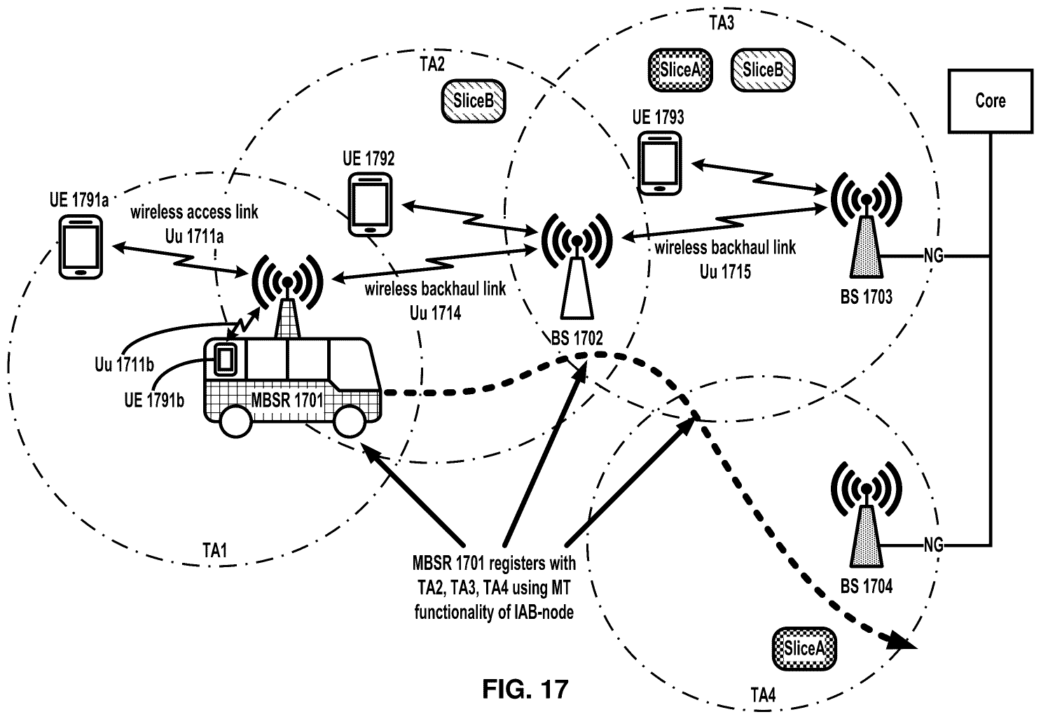

FIG. 17 illustrates an example of a mobile base station relay (MBSR). The figure illustrates an MBSR 1701. The MBSR 1701 may comprise IAB functionality, for example, similar to the BS 1601 and/or IAB-node 1621 illustrated in FIG. 16. As noted above, IAB functionality enables base stations (e.g., gNB, eNB, MeNB, SgNB, etc.) to act as relay nodes (e.g., wireless relay nodes).

In the example figure, several user equipment (UE 1791, UE 1792, UE 1793) access a network via wireless access links of several base stations (MBSR 1701, BS 1702, BS 1703, BS 1704). The MBSR 1701 is a mobile base station, for example, a base station that is configured and/or intended to move within the network. The MBSR 1701 is illustrated as a bus with an integrated base station, but it will be understood that base station mobility may be implemented in any suitable manner (train, boat, aerial drone, etc.). The UE 1791a is illustrated as being outside of the bus, whereas the UE 1791b is illustrated as being inside the bus (e.g., moving with and/or transported by the MBSR 1701).

As one use-case scenario for MBSRs, consider that the MBSR 1701 may be located (e.g., parked) at the edge of a coverage area of a non-mobile base station (e.g., BS 1702) to extend a coverage area of the network. Even if UE 1791a is at or beyond an edge of a coverage area of the BS 1702, the UE 1791a may access BS 1702 (and the upstream network) via MBSR 1701 (and/or a multi-hop chain of additional MBSRs, not illustrated). Accordingly, MBSRs may be advantageously or spontaneously deployed if coverage is needed in a remote area (an off-the-grid music festival, a rescue operation, etc.).

As another use-case scenario for MBSRs, consider that the MBSR 1701 may transport a plurality of users (e.g., UE 1791b plus several other passenger UEs) through various coverage areas (of BS 1702, BS 1703, BS 1704, etc.). If the MBSR 1701 lacked MBSR capabilities (i.e., if the MBSR 1701 was a normal bus), then each of the passenger UEs would re-register in each TA (TA2, TA3, TA4, etc.). This would predictably result in a sudden spike of control signaling in each base station's coverage area as the bus entered. A benefit of MBSR is that the need for control signaling can be reduced. For example, because MBSR 1701 has the DU functionality of an IAB-node, each of the users (UE 1791b, etc.) can remain in a coverage area of the MBSR 1701. From the perspective of the passenger UEs, MBSR 1701 remains “stationary”. In an example, only the MBSR 1701 itself re-registers in each tracking area (e.g., using its MT functionality), thereby reducing the amount of control signaling. MBSRs of this kind may be advantageously deployed along high-traffic corridors (e.g., on a bus or in a train car) to limit waves of registration requests.

As noted above, IAB functionality enables MBSR 1701/BSs 1702-1704 to act as wireless relay nodes. MBSR 1701 and BS 1702 may communicate upstream via wireless backhaul links (Uu 1714, Uu 1715). In the example figure, BS 1703 and BS 1704 have interfaces with a core of the network. In the example figure, MBSR 1701 and BSs 1702-1704 have IAB functionality.

MBSR 1701 and BS 1702 may operate as IAB-nodes. Accordingly, MBSR 1701 and BS 1702 may have DU functionality and MT functionality.

BS 1703 and BS 1704 may operate as IAB-donors. BSs 1703-1704 may have CU functionality and DU functionality.

Unlike the BS 1601 illustrated in FIG. 16, MBSR 1701 is mobile. Accordingly, MBSR 1701 may move through the coverage areas of BS 1702 and BS 1703, and may sometimes be regarded (due to its MT functionality), from an upstream perspective, as any other wireless device (e.g., UE).

MBSR 1701 and BSs 1702-1704 may belong to different tracking areas, respectively (TA1, TA2, TA3, TA4 in the illustration). Each may transmit (e.g., broadcast) a SIB indicating its tracking area. In an example, the respective TAs may be associated with different registration areas (e.g., a UE may re-register upon exiting and/or entering a TA).

Moreover, MBSR 1701 and BSs 1702-1704 may have different supports and/or restrictions. In the illustrated example, TA2 supports SliceA and SliceB, TA3 supports SliceB (e.g., does not support SliceA), and TA4 supports SliceA (e.g., does not support SliceB).

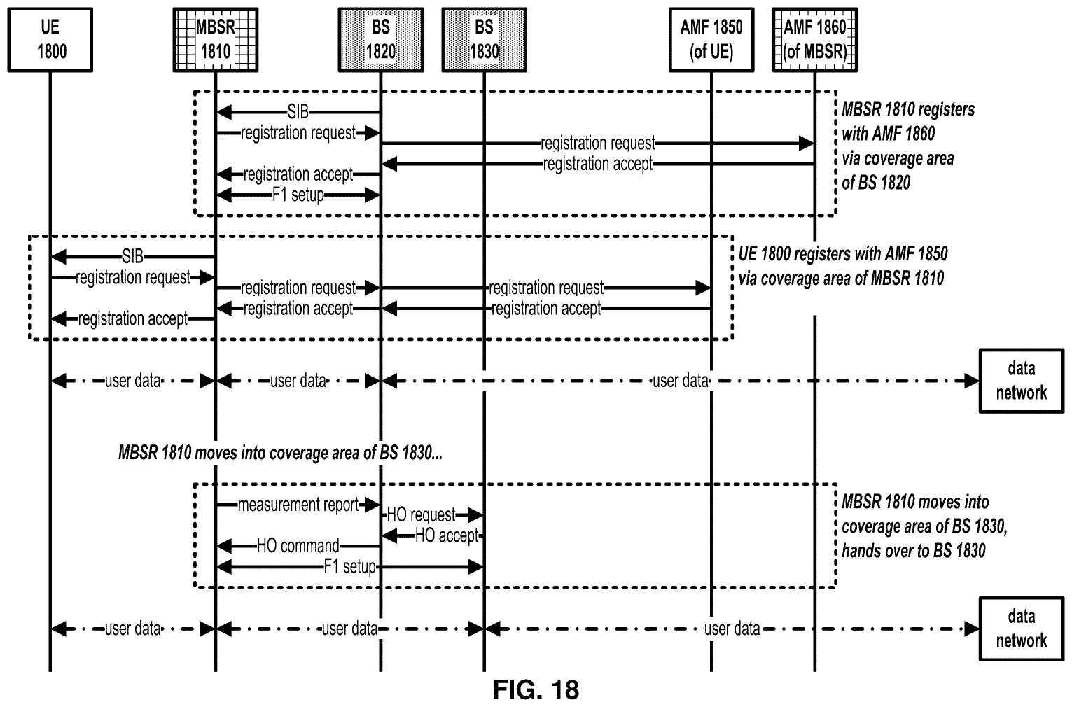

FIG. 18 illustrates an example of registration of an MBSR and a wireless device. For illustration purposes, the figure includes a UE 1800, an MBSR 1810, a BS 1820, a BS 1830, an AMF 1850 (serving UE 1800), and an AMF 1860 (serving MBSR 1810). Although AMF 1850 and AMF 1860 are illustrated as different AMFs, it will be understood that in some scenarios, the same AMF may serve both UE 1800 and MBSR 1810.

In the figure, MBSR 1810 registers with AMF 1860. The registration is via BS 1820 (e.g., a distributed unit (DU) of BS 1820, a cell of BS 1820, etc.). The MBSR 1810 receives a system information block (SIB) from BS 1820. The SIB may comprise, for example, a PLMN ID associated with a network of BS 1820, a tracking area code (TAC) associated with a tracking area of BS 1820, a new radio cell global identifier (NCGI) associated with the cell of BS 1820, etc. Based on receiving the SIB, MBSR 1810 sends a registration request to BS 1820. The BS 1820 sends the registration request to a selected AMF (AMF 1860). The AMF 1860 may be selected by the BS 1820. Based on receiving the registration request, AMF 1860 sends a registration accept to BS 1820. BS 1820 sends the registration accept to MBSR 1810.

MBSR 1810 may operate as an IAB-node. BS 1820 may operate as an IAB-node and/or an IAB-donor. Based on registration of MBSR 1810, a Uu interface may be set up between MBSR 1810 (e.g., an MT functionality of MBSR 1810) and BS 1820 (e.g., a DU functionality of BS 1820). An F1 interface may be set up between MBSR 1810 (e.g., a DU functionality of MBSR 1810) and an IAB-donor (e.g., a CU functionality of BS 1820 or a CU functionality of an IAB-donor further upstream). The F1 interface may be set up over the Uu interface. The F1 interface may be via one or more wireless backhaul links.

The UE 1800 registers with AMF 1850 via a coverage area of MBSR 1810. For example, UE 1800 receives a SIB from MBSR 1810. Based on receiving the SIB, UE 1800 sends a registration request to MBSR 1810. MBSR 1810 sends the registration request to AMF 1850 via BS 1820. Based on receiving the registration request, AMF 1850 sends a registration accept to UE 1800 (e.g., via BS 1820 and MBSR 1810).

Based on, for example, the registration of MBSR 1810 via BS 1820 and the registration of UE 1800 via MBSR 1810/BS 1820, UE 1800 may exchange (e.g., send and/or receive) user data with a data network.

In the figure, MBSR 1810 moves into a coverage area of BS 1830. As a result, MBSR 1810 is handed over from BS 1820 to BS 1830. For example, MBSR 1810 sends a measurement report to BS 1820. The measurement report may comprise one or more measurements of one or more reference signals of BS 1830. Based on the measurement report, BS 1820 sends a handover request to BS 1830. Based on receiving the handover request, BS 1830 sends a handover accept to BS 1820. Based on receiving the handover accept from BS 1830, BS 1820 sends a handover command to MBSR 1810. An F1 interface may be set up between MBSR 1810 and BS 1830. The F1 interface between MBSR 1810 and BS 1820 may no longer be used (e.g., release, suspended, etc.).

UE may does not perform a handover and may be unaware that MBSR 1810 has performed a handover. For example, from the perspective of UE 1800, MBSR 1810 may be similar to any other base station (e.g., BS 1820, BS 1830, etc.).

Based on, for example, the handover of MBSR 1810 to BS 1830, UE 1800 may exchange (e.g., send and/or receive) user data with the data network.

In existing technologies, a wireless device may access a network via a wireless access link of a mobile base station (e.g., MBSR). The MBSR may access the network via one or more wireless backhaul links (to a second base station, third base station, etc.). The MBSR may be associated with a particular tracking area. The tracking area associated with the MBSR (e.g., TA1) may be fixed. For example, even if the MBSR hands over from the second base station (associated with TA2) to the third base station (associated with TA3), the tracking area associated with the MBSR (TA1) does not change. Accordingly, the tracking area of the wireless device does not change.

Tracking areas have significance to the wireless device for at least the following reasons. For example, consider a wireless device that reduces power consumption by transitioning to an idle/inactive state. When idle/inactive, the wireless device may move within the network. While idle/inactive, the wireless device may monitor system information blocks (SIBs) transmitted by nearby base stations. If a received SIB indicates a change in tracking area (e.g., from TA2 to TA3), then the wireless device may transition to an RRC connected state and re-register with the network. By re-registering upon entry to a new tracking area, the wireless device can provide the network with an updated location.

Updating has benefits for the network and the wireless device. For example, the network can quickly and efficiently locate and page the wireless device if downlink data becomes available. However, re-registration consumes power and network resources (e.g., signaling overhead). Accordingly, when implementing MBSR, it may be beneficial to assign a fixed tracking area. As the MBSR moves through the network, the MBSR itself may need to re-register (e.g., when moving from TA2 to TA3). But the wireless device observes a single tracking area (TA1, associated with the MBSR), and does not need to re-register. Resource consumption is reduced, especially if there are a large number of wireless devices accessing the network via the MBSR. For example, suppose there are ten wireless devices accessing the network via an MBSR associated with a dynamic TA. If the MBSR changes tracking areas, then the MBSR and all ten wireless devices may perform re-registration (eleven total re-registrations). By contrast, if the MBSR has a fixed TA, then there is only one re-registration (the re-registration of the MBSR).

Accordingly, it can be beneficial to reduce re-registration by assigning MBSRs with a fixed TA. But there are complications as well. For example, some areas of a network may be associated with particular supports and/or restrictions, and other areas of the network may be associated with different supports and/or restrictions. Re-registration offers an opportunity for the wireless device to gather new information about the particular area the wireless device happens to be passing through. However, if re-registration is avoided, then the wireless device may miss the new information. The wireless device may attempt to use services which were supported in the old area, but are not supported in the new area. Additionally or alternatively, the wireless device may fail to take advantage of services which are supported in the new area, but weren't supported in the old area.

For example, consider the scenario of FIG. 17 described above. Suppose that UE 1791b accesses the network via a wireless access link of MBSR 1701 (Uu 1711b). The MBSR 1701 accesses the network via two wireless backhaul links (Uu 1714 between MBSR 1701 and BS 1702 and Uu 1715 between BSs 1702-1703). Suppose further that BS 1703 supports ultra reliable low latency communication (URLLC) services (e.g., SliceA in FIG. 17), but BS 1702 does not. If UE 1791b attempts to use URLLC via Uu 1711b, errors may occur in the backhaul (which relies on a wireless backhaul link, Uu 1714, that does not support URLLC).

As another example, suppose that MBSR 1701 travels into the coverage area of BS 1703. MBSR 1701 may re-register with BS 1703. As a result, Uu 1714 (the only link in the backhaul that does not support URLLC) is removed from the multi-hop chain. If the UE 1791b itself had re-registered via BS 1703, then the UE 1791b may have been informed that URLLC is supported in the coverage area of BS 1703. However, UE 1791b accesses the network via MBSR 1701, which has a fixed tracking area (TA1). Because MBSR 1701 has a fixed tracking area, UE 1791b does not re-register. Because UE 1791b does not re-register, UE 1791b may not be aware that an opportunity for URLLC service is available, and may miss an opportunity to obtain URLLC service.

In accordance with aspects of the disclosure, new techniques are introduced to avoid the deficiencies described above. In an example, a first base station (e.g., an MBSR) may indicate, to a wireless device, a change in a wireless backhaul link of the first base station. The change may be indicated in, for example, a SIB, RRC message, and/or NAS message. In an example, the first base station may indicate, to the wireless device, an area (and/or a change of area) of the first base station (e.g., a tracking area associated with a wireless backhaul link between the first base station and a second base station). In an example, the first base station may indicate, to the wireless device, supports and/or restrictions (and/or a change in supports and/or restrictions) of the first base station (e.g., the supports and/or restrictions associated with the wireless backhaul link between the first base station and the second base station). In an example, the first base station may prompt the wireless device to re-register (e.g., indicate that re-registration is allowed, available, and/or potentially advantageous). Based on the foregoing indication(s), the wireless device may re-register with the network.

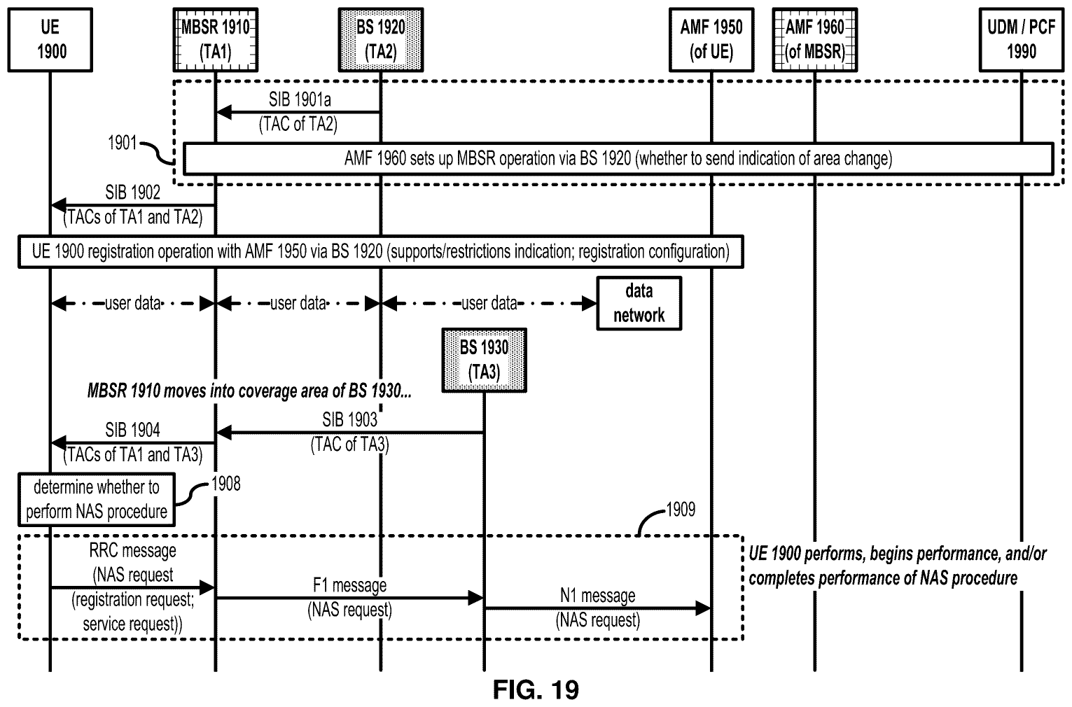

FIG. 19 illustrates an example of MBSR mobility in accordance with aspects of the disclosure. For illustration purposes, the figure includes a UE 1900, an MBSR 1910, a BS 1920, a BS 1930, an AMF 1950 (serving UE 1900), an AMF 1960 (serving MBSR 1910), and a UDM/PCF 2090.

Although BS 1920 and BS 1930 are illustrated as different BSs, it will be understood that in some scenarios, the same BS may constitute both BS 1920 and BS 1930 (e.g., BS 1920 and BS 1930 may represent different cells of a same base station rather than different base stations). In the figure, MBSR 1910, BS 1920, and BS 1930 are associated with different respective tracking areas TA1, TA2, and TA3. Each of the TAs may have different supports and/or restrictions, as noted above.

Although AMF 1950 and AMF 1960 are illustrated as different AMFs, it will be understood that in some scenarios, the same AMF may serve (e.g., may be selected to serve) both UE 1900 and MBSR 1910. Although BS 1920 and BS 1930 are illustrated as different BSs, it will be understood that in some scenarios, BS 1920 and BS 1930 may represent different cells of a same base station.

At 1901, MBSR 1910 is set up to operate as a mobile base station relay. For example, BS 1920 transmits (e.g., broadcasts) a SIB 1901a. In an example, SIB 1901a may be broadcast intermittently by BS 1920. SIB 1901a may comprise one or more area indicators.

In the present disclosure, an area indicator may refer to an identifier and/or indicator of a particular area. For example, the area may be a cell coverage area, tracking area, and/or registration area. The cell coverage area, tracking area, and/or registration area may be identified and/or indicated using a tracking area code (TAC), tracking area identifier (TAI), new radio cell global identifier (NCGI), etc. The area may be associated with one or more supports and/or restrictions. For example, in a first area, a first service may be supported or not supported; restricted or not restricted; allowed or not allowed. In the first area, a second service may be associated with support and/or restrictions which are the same as or different from the first service. In a second area, the first service may be supported or not supported; restricted or not restricted; allowed or not allowed. In the second area, the second service may be associated with support and/or restrictions which are the same as or different from the first area.

SIB 1901a may comprise an area indicator associated with BS 1920 and/or a cell of BS 1920 (e.g., TAC, NCGI, etc.). In this present example, the area indicator is a TAC. The TAC indicates TA2, the TA associated with BS 1920.

MBSR 1910 may operate as an MBSR (e.g., as an IAB-node). MBSR 1910 may receive SIB 1901a from BS 1920. Based on SIB 1901a (e.g., the system information provided in the SIB 1901a), the MBSR 1910 may set up an RRC connection with BS 2020. Based on the SIB 1901a (e.g., the system information provided in the SIB 1901a), the MBSR 1910 may register with the network. The registration may be via BS 1920 (e.g., the RRC connection with BS 2020). The MBSR 1910 may register with AMF 1960. AMF 1960 may be selected by BS 1920 to serve MBSR 1910. AMF 1960 may serve MBSR 1910. MBSR 1910 may store SIB 1901a or at least a portion thereof (e.g., TA2, the TAC associated with BS 1920).

The AMF 1960 and/or the UDM/PCF 1990 may send, to the MBSR 1910 and/or BS 1920, an indication, configuration, and/or parameter indicating whether to send, to the UE 1900, an indication of an area change. For example, the PCF may send, to the UDM, a request for subscription information of the UE 1900. The PCF may receive, from the UDM via AMF 1960, the subscription information of UE 1900. Based on subscription information of the UE 1900, the PCF may determine whether to send, to UE 1900, the indications of the area change. The indication of area change may be sent in several different ways, as will be discussed in greater detail below. During setup, AMF 1960 may indicate to MBSR 1910 and/or BS 1920 how to indicate the area change to UE 1900.

To operate as an MBSR (e.g., as an IAB-node with DU functionality), MBSR 1910 may act as a base station and/or base station distributed unit with respect to downstream devices (e.g., UE 1900). In the figure, MBSR 1910 transmits (e.g., broadcasts) SIB 1902. In an example, SIB 1902 may be broadcast intermittently within a coverage area of MBSR 1910. The SIB 1902 may comprise one or more area indicators.

The SIB 1902 may comprise an area indicator associated with MBSR 1910 and/or a cell of MBSR 1910 (e.g., TAC, NCGI, etc.). In this present example, the area indicator is a TAC. The TAC indicates TA1, the TA associated with MBSR 1910. Additionally or alternatively, the SIB 1902 may comprise the area indicator associated with BS 1920 and/or the cell of BS 1920 (TA2), as will be discussed in greater detail below.

In existing technologies, the backhaul of the MBSR 1910 may be transparent to UE 1900. For example, MBSR 1910, a mobile base station, may appear to be similar to other (non-mobile) base stations. For example, a tracking area associated with MBSR 1910 may be fixed (similar to other base stations). As MBSR 1910 moves within the network (e.g., from one tracking area to another), the tracking area of the backhaul (and the supports and/or restrictions associated with the backhaul) may change. According to existing techniques, UE 1900 may monitor SIBs to observe whether a TA has changed. If the TA changes, then UE 1900 may re-register and be notified, during registration, of any changes in support and/or restrictions of the network. But according to existing techniques, UE 1900 will observe a fixed TA (associated with the wireless access link of the MBSR 1910). The UE 1900 will observe the same TA (that of MBSR 1910) even if supports and/or restrictions associated with the backhaul change. As a result, UE 1900 may miss opportunities to re-register and remain ignorant of changes in support and/or restrictions of the network.

To alleviate this problem, MBSR 1910 may modify SIB 1902 to include an area indicator of one or more other base stations (e.g., base stations associated with wireless backhaul links upstream of MBSR 1910). For example, SIB 1902 may comprise an area indicator associated with BS 1920 and/or a cell of BS 1920 (e.g., TAC, NCGI, etc.). In the present example, the area indicator is TA2, the TA associated with BS 1920. Accordingly, SIB 1902 may comprise two or more TACs, for example, a first TAC associated with the transmitter of SIB 1902 (MBSR 1910) and one or more second TACs associated with one or more upstream nodes (e.g., the parent node BS 1920, a parent of parent node BS 1920, the IAB-donor upstream of parent node BS 1920, etc.).

UE 1900 may receive SIB 1902 from MBSR 1910. Based on the SIB 1902 (e.g., system information provided in the SIB 1902), UE 1900 may register with the network via MBSR 1910. The UE 1900 may register with AMF 1950. AMF 1950 may serve UE 1900. Based on the registration, UE 1900 may exchange (e.g., send and/or receive) user data with a data network.

If MBSR 1910 is configured to transmit multiple area indicators, then precise terminology may be introduced to facilitate categorization and/or description. For example, when MBSR 1910 transmits the area indicator associated with MBSR 1910, this TAC may be referred to simply as “TAG”, or alternatively, as “access”, “primary”, “master”, “basic”, and/or “main” TAC. When MBSR 1910 transmits the area indicator(s) of other nodes (e.g., parent nodes), these TACs may be referred to as “backhaul”, “secondary”, “additional”, “assistant”, “sub”, and/or “super” TACs. The information elements (IEs) and/or fields that carry these area indicators may have analogous categories and/or names (e.g., “access tracking area” vs. “backhaul tracking area”, “tracking area basic information” vs. “tracking area assistance information”, etc.).

The UE 1900 may store SIB 1902 and/or contents thereof, including the first area indicator (e.g., a TAC of MBSR 1910 indicating TA1) and the one or more second area indicators (e.g., a TAC of BS 1920 indicating TA2).

Based on receiving the SIB 1902, UE 1900 registers with the network. For example, UE 1900 may send a registration request to MBSR 1910 via a wireless access link, which may be forwarded to BS 1920 via a wireless backhaul link, which may be forwarded to (selected) AMF 1950. AMF 1950 may send a registration response to UE 1900 (e.g., via BS 1920 and MBSR 1910). The registration response may comprise an indication of support and/or restrictions. The supports and/or restrictions may be associated with one or more requests included in the registration request. For example, UE 1900 may request support for Slice A and Slice B. AMF 1950 may indicate that SliceA is accepted (e.g.: supported; and/or not restricted) and/or that SliceB is rejected (e.g.: not supported; and/or restricted).

In an example, when indicating supports and/or restrictions, the network (e.g., AMF 1950) may send a cause value to UE 1900. For example, the cause value may indicate why a request for a particular service is rejected. For example, the cause value may indicate that rejection is due to usage of (e.g., reliance on) MBSR 1910 and/or a wireless backhaul link. For example, the cause value may indicate that rejection is due to a location of MBSR 1910 and/or the wireless backhaul link.

In an example, the network (e.g., AMF 1950) may send a registration indication (e.g., registration configuration, parameter, etc.) to UE 1900. For example, the registration indication may indicate that UE 1900 performs a NAS procedure (e.g., registration, re-registration request and/or service request) based on a change of an area indicator and/or secondary area indicator (as will be discussed in greater detail below).

After registration is complete, UE 1900 may exchange (e.g., send and/or receive) user data with the data network. MBSR 1910 may move within, for example, a coverage area of BS 1920. MBSR 1910 may move into another coverage area.

In the figure, MBSR 1910 moves into a coverage area of BS 1930. BS 1930 may transmit, and MBSR 1910 may receive, a SIB 1903. SIB 1903 may comprise an area indicator associated with BS 1930 (TAC3 in the present example). MBSR 1910 may store SIB 1903 or at least a portion thereof (e.g., TA3, the TAC associated with BS 1930).

MBSR 1910 may transmit (e.g., broadcast) SIB 1904. Based on receiving the SIB 1903, MBSR 1910 may modify future SIBs (e.g., SIB 1904). For example, MBSR 1910 may modify the one or more second area indicators included in SIB 1904.

As an example, based on SIB 1903 comprising a new area indicator (TA3), MBSR 1910 may add TA3 to the one or more secondary area indicators included in SIB 1904. Additionally or alternatively, MBSR 1910 may drop TA2 from the one or more secondary area indicators included in SIB 1904.

As an example, based on determining to request, requesting, receiving a handover accept, transmitting a handover command, and/or completing handing over to BS 1930, MBSR 1910 may add the tracking area associated with BS 1930 (TA3) to the one or more secondary area indicators included in SIB 1904. Additionally or alternatively, MBSR 1910 may drop the tracking area associated with BS 1920 (TA2) from the one or more secondary area indicators included in SIB 1904.

At 1908, as shown in the figure, UE 1900 determines whether to perform (e.g., trigger) a NAS procedure. The determining may be based on receiving SIB 1904. For example, based on a change of the one or more secondary area indicators included in SIB 1904 (e.g., TA2 dropped and/or TA3 added), UE 1900 may determine to perform the NAS procedure. As will be discussed in greater detail below, the NAS procedure may comprise, for example, a registration procedure, re-registration procedure, and/or service request procedure.

Additionally or alternatively, UE 1900 may determine to perform (e.g., trigger) the NAS procedure based on other considerations. As an example, if UE 1900 has received the registration indication (e.g., registration configuration, parameter, etc., as noted above) indicating that UE 1900 is allowed, required, and/or commanded to perform the NAS procedure based on a change of an area indicator and/or secondary area indicator (e.g., in during registration with AMF 1950, as described previously), then the UE 1900 performs the NAS procedure.

As an example, if UE 1900 desires or requires support for a particular service, and that service was not supported in TA2, then the UE 1900 may determine to perform the NAS procedure based on the possibility that the service is supported in TA3. By contrast, if UE 1900 has no unmet desires or requirements, then re-registration may be skipped.

As another example, if UE 1900 is using a particular service, then the UE 1900 may determine to re-register based on the possibility that the service is no longer supported in TA3. Under such a circumstance, continued attempts to use the unsupported service may overload the network. This consideration may be reserved for particular designated services (e.g., URLLC service) and/or particular designated restrictions.

At 1909, as shown in the figure, UE 1900 performs, begins performance, and/or completes performance of the NAS procedure. The performing at 1909 may be based on the determining to perform the NAS procedure at 1908. The NAS procedure may comprise, for example, a registration procedure, re-registration procedure, and/or service request procedure. For example, UE 1900 may transmit a message to MBSR 1910. For example, the message may comprise an RRC message. For example, the message may comprise a NAS request. For example, the message may comprise a registration request. For example, the message may comprise a service request. The MBSR 1910 may send an F1 message to BS 1930. The F1 message may comprise the NAS request. The BS 1930 may send an N1 message to the AMF 1950. The N1 message may comprise the NAS request.

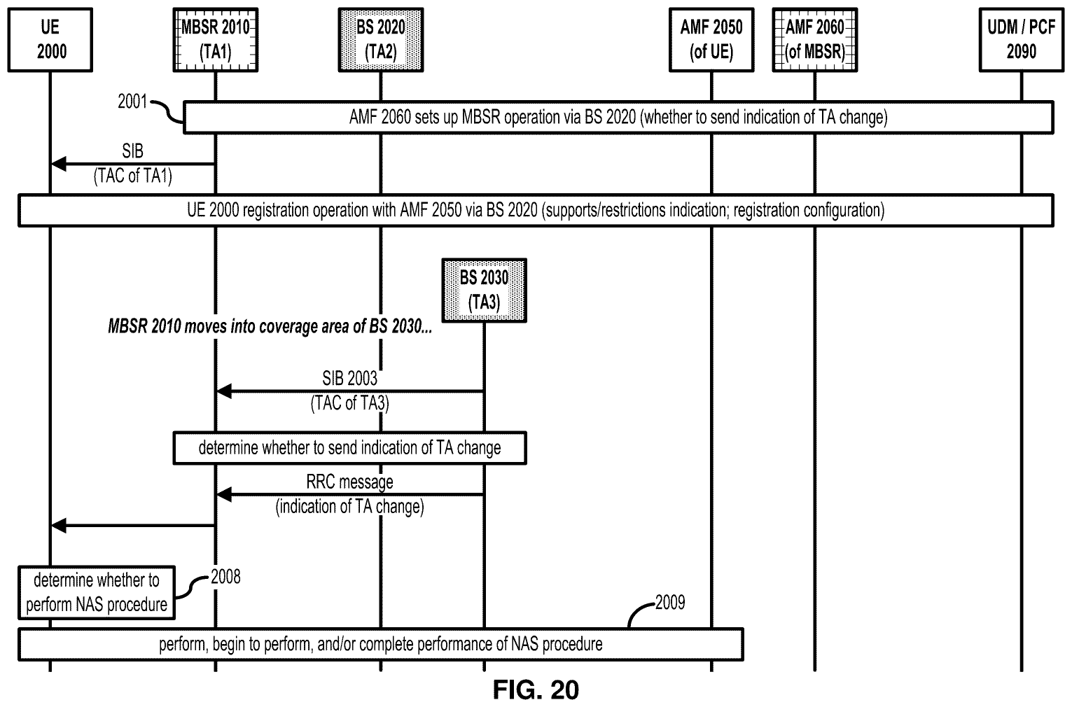

FIG. 20 illustrates an example of MBSR mobility in accordance with aspects of the disclosure. For illustration purposes, the figure includes a UE 2000, an MBSR 2010, a BS 2020, a BS 2030, an AMF 2050 (serving UE 2000), and an AMF 2060 (serving MBSR 2010). These elements may be similar to the elements illustrated in previous figures; for brevity, redundant details will be omitted. The figure includes a unified data management (UDM) and/or policy control function (PCF) 2090.

At 2001 in the figure, similar to the previous figure, MBSR 2010 is set up to operate as a mobile base station so that UE 2000 can access the network via MBSR 2010 and BS 2020. For brevity, redundant details will be omitted.

MBSR 2010 transmits (e.g., broadcasts) a SIB. In an example, the SIB may be broadcast intermittently within a coverage area of MBSR 2010. The SIB 2002 may comprise an area indicator associated with MBSR 2010 and/or a cell of MBSR 2010 (e.g., TAC, NCGI, etc.). In this present example, the area indicator is a TAC. The TAC indicates TA1, the TA associated with MBSR 2010.

UE 2000 may receive the SIB from MBSR 2010. Based on the SIB (e.g., system information provided in the SIB), UE 2000 may establish an RRC connection with MBSR 2010.

Based on receiving the SIB, UE 2000 registers with the network. For example, UE 2000 may send a registration request to MBSR 2010 via a wireless access link, which may be forwarded to BS 2020 via a wireless backhaul link, which may be forwarded to (selected) AMF 2050. AMF 2050 may send a registration response to UE 2000 (e.g., via BS 2020 and MBSR 2010). As described previously, the registration response may comprise an indication of support and/or restrictions; a registration indication; etc.

After registration is complete, UE 2000 may exchange (e.g., send and/or receive) user data with the data network. MBSR 2010 may move within, for example, a coverage area of BS 2020. MBSR 2010 may move into another coverage area. In the figure, MBSR 2010 moves into a coverage area of BS 2030. BS 2030 may transmit, and MBSR 2010 may receive, a SIB 2003. SIB 2003 may comprise an area indicator associated with BS 2030 (TAC3 in the present example).

MBSR 2010 and/or BS 2030 may determine whether to send, to UE 2000, an indication of an area change.

In an example, MBSR 2010 may determine whether or not to send, to the UE 2000, the indication of the area change. For example, the determining may be based on the indication of whether to send the indication of the area change received during the registration of UE 2000. For example, the determining may be based on mobility of MBSR 2010 (e.g., receiving the SIB 2003 from BS 2030 indicating an area change, receiving the SIB 2003 from BS 2030 comprising an area indicator (e.g., TA3) different from the area indicator in SIB 2001 (TA2), triggering handover to BS 2030, and/or completing handover to BS 2030). MBSR 2010 may send a message to UE 2000 (e.g., an RRC message) indicating the area change. The sending may be based on one or more of the foregoing factors.

In an example, BS 2030 may determine whether or not to send, to the UE 2000, the indication of the area change. For example, the determining may be based on the indication of whether to send the indication of the area change received during the registration of UE 2000. For example, the determining may be based on mobility of MBSR 2010 (e.g., receiving a handover request from BS 2020, sending a handover accept to BS 2020, and/or completing handover of MBSR 2010 from BS 2020). BS 2030 may send a message to UE 2000 (e.g., an RRC message via MBSR 2010) indicating the area change. The sending may be based on one or more of the foregoing factors.

At 2008 in the figure, similar to the previous figure, UE 2000 determines whether to perform (e.g., trigger) a NAS procedure. The determining at 2008 may be based on the receiving the RRC message (e.g., the indication of the area change). At 2009 in the figure, similar to the previous figure, UE 2000 performs the NAS procedure. The performing the NAS procedure may be based on determining, at 2008, to perform the NAS procedure. For brevity, redundant details will be omitted.

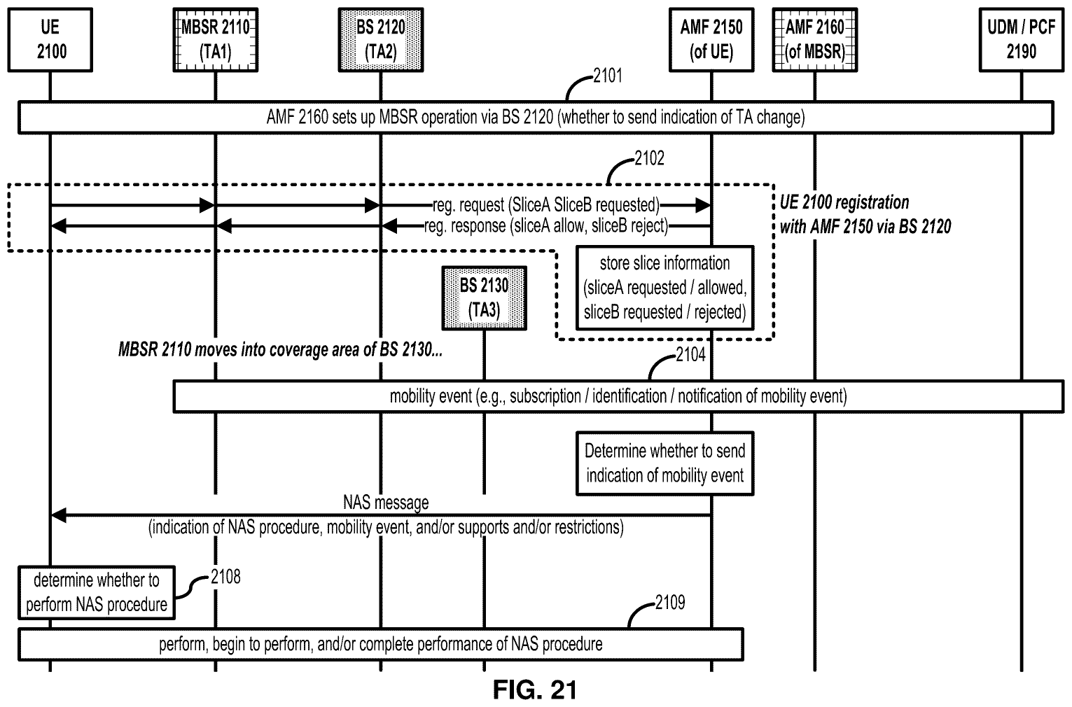

FIG. 21 illustrates an example of MBSR mobility in accordance with aspects of the disclosure. For illustration purposes, the figure includes a UE 2100, an MBSR 2110, a BS 2120, a BS 2130, an AMF 2150 (serving UE 2100), an AMF 2160 (serving MBSR 2110), and a UDM/PCF 2190. These elements may be similar to the elements illustrated in previous figures; for brevity, redundant details will be omitted.

At 2101 in the figure, similar to the previous figures, MBSR 2110 is set up to operate as a mobile base station so that UE 2100 can access the network via MBSR 2110 and BS 2120. For brevity, redundant details will be omitted.

At 2102, UE 2100 registers with the network. The UE 2100 may send a registration request to MBSR 2110. The MBSR 2110 may send the registration request to BS 2120. The BS 2120 may select an AMF (e.g., AMF 2150) to serve UE 2100. The BS 2120 may send, to the AMF 2150, the registration request. The AMF 2150 may determine one or more supports and/or restrictions. The AMF 2150 may send, to the UE 2100 via BS 2120 and MBSR 2110, a registration response. The registration response may indicate the one or more supports and/or restrictions. The registration response may be, for example, a registration accept or a registration rejection.

The AMF 2150 may store information relating to the indications sent to UE 2100. For example, in the figure, UE 2100 requests network slices SliceA and SliceB. The AMF 2150 allows SliceA and rejects SliceB. The AMF 2150 may store slice information associated with UE 2100. For example, AMF 2150 stores information indicating that SliceA and/or SliceB were requested by UE 2100. For example, AMF 2150 stores information indicating that SliceA was accepted. For example, AMF 2150 stores information indicating that SliceB was rejected.

In the figure, similar to the previous figure, MBSR 2110 moves into a coverage area of BS 2130. For brevity, redundant details will be omitted.

At 2104, one or more of MBSR 2110, BS 2120, BS 2130, AMF 2150, AMF 2160, and/or UDM/PCF 2190 may determine, detect, identify, notify, and/or be notified that a mobility event has occurred. Several detailed examples are illustrated in the figures that follow. The mobility event may be associated with mobility of MBSR 2110 (e.g., moving into the coverage area of BS 2130).

The AMF 2150 may determine, detect, identify, notify, and/or be notified that a mobility event has occurred. Based on the mobility event, AMF 2150 may determine to indicate the mobility event to UE 2100 (e.g., indicate that a mobility event has occurred, indicate that a mobility event of a MBSR and/or IAB-node has occurred, identify the mobility event or a type/category thereof, etc.). Based on the mobility event, AMF 2150 may determine whether to indicate, notify, command, and/or prompt UE 2100 to perform a NAS procedure. Based on the mobility event, AMF 2150 may determine whether to indicate and/or identify, to the UE 2100, supports and/or restrictions (e.g., updated supports and/or restrictions). The indication, notification, command, and/or prompt may be sent to UE 2100 in a NAS message.

For example, the mobility event may be associated with mobility of MBSR 2110 into a coverage area of BS 2130 (e.g., triggering of handover from BS 2120 to BS 2130, commencement of handover from BS 2120 to BS 2130, completion of handover from BS 2120 to BS 2130, etc.).

In an example, the AMF 2150 may determine that SliceA, which was requested by UE 2100 and allowed in TA2, is not supported (e.g., would be rejected) in TA3. AMF 2150 may determine that UE 2100 may perform the NAS procedure. The determining may be based on the slice support in TA2 and TA3 being different. For example, AMF 2150 may notify UE 2100 of a registration opportunity, indicate allowance of UE 2100 to register, prompt the UE 2100 to register, command the UE 2100 to register, etc.

In another example, the AMF 2150 may determine that SliceB, which was requested by UE 2100 and rejected in TA2, is supported (e.g., would be allowed) in TA3. AMF 2150 may determine that UE 2100 may perform the NAS procedure. The determining may be based on the slice support in TA2 and TA3 being different. For example, AMF 2150 may notify UE 2100 of a registration opportunity, indicate allowance of UE 2100 to register, prompt the UE 2100 to register, command the UE 2100 to register, etc.

In another example, the AMF 2150 may determine that Slice C, which was not requested by UE 2100, is supported (e.g., would be allowed) in TA3. Based on Slice C not being requested by UE 2100, AMF 2150 may determine that the indication, notification, command, and/or prompt is not sent to UE 2100. Alternatively, based on the slice support in TA2 and TA3 being different, AMF 2150 may determine that UE 2100 may optionally perform the NAS procedure, i.e., may determine to notify UE 2100 that different slice support has become available, identify the slice that has become available, and/or prompt UE 2100 to re-register if UE 2100 has come to desire and/or require non-requested slice support.

In another example, the AMF 2150 may determine that SliceA is not supported (e.g., would be rejected) in TA3 and that Slice B and Slice C are supported (e.g., would be allowed) in TA3. AMF 2150 may indicate to UE 2100 that SliceA is not supported (e.g., is rejected, would be rejected) and that Slice B and Slice C are supported (e.g., are allowed, would be allowed if requested, etc.). The indicating may be based on the slice support in TA2 and TA3 being different. For example, AMF 2150 may notify UE 2100 of a registration opportunity, indicate allowance of UE 2100 to register, prompt the UE 2100 to register, command the UE 2100 to register, etc.

MBSR 2110 may determine whether or not to send, to the UE 2100, an indication of an area change. For example, the determining may be based on receiving (e.g., during the setup 2101 of MBSR 2110) the indication of whether to send the indication of the area change. For example, the determining may be based on mobility of MBSR 2110 (e.g., receiving the SIB 2103 from BS 2130 indicating an area change, receiving the SIB 2103 from BS 2130 comprising an area indicator different from the area indicator in SIB 2101, triggering handover to BS 2130, and/or completing handover to BS 2130). MBSR 2110 may send a message to UE 2100 (e.g., an RRC message) indicating the area change. The sending may be based on one or more of the foregoing factors.

At 2108 in the figure, similar to the previous figure, UE 2100 determines whether to perform (e.g., trigger) a NAS procedure. The determining at 2108 may be based on the receiving the NAS message (e.g., the indication to perform the NAS procedure, the indication of the mobility event, the indication of supports and/or restrictions, etc.). At 2109 in the figure, similar to the previous figures, UE 2100 performs the NAS procedure. The performing the NAS procedure may be based on determining, at 2108, to perform the NAS procedure. For brevity, redundant details will be omitted.

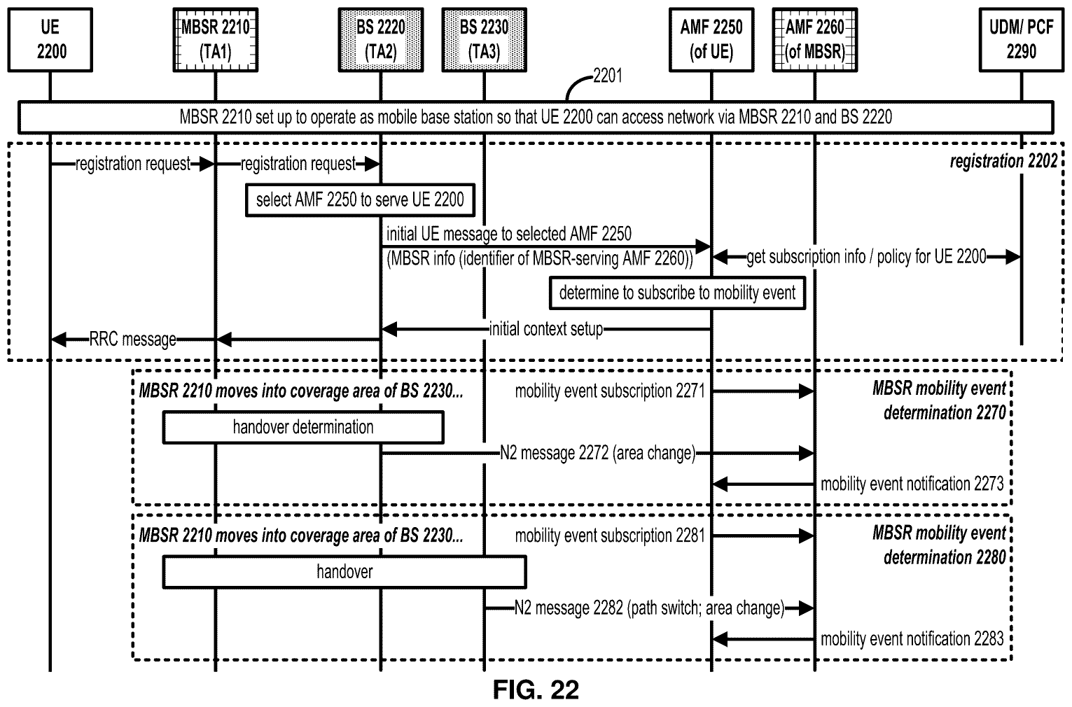

FIG. 22 illustrates examples of determination, detection, identification, and/or notification of a mobility event. For illustration purposes, the figure includes a UE 2200, an MBSR 2210, a BS 2220, a BS 2230, an AMF 2250 (serving UE 2200), and an AMF 2260 (serving MBSR 2210). These elements may be similar to the elements illustrated in previous figures; for brevity, redundant details will be omitted. The figure includes a UDM/PCF 2290.

At 2201 in the figure, similar to the previous figures, MBSR 2210 is set up to operate as a mobile base station so that UE 2200 can access the network via MBSR 2210 and BS 2220. For brevity, redundant details will be omitted. As noted above, during setup of MBSR 2210, BS 2220 may select the AMF that serves MBSR 2210 (e.g., AMF 2260), determine an identifier of the AMF that serves MBSR 2210, and/or store the identifier.

At 2202 in the figure, UE 2200 registers with the network. The UE 2200 sends a registration request to BS 2220 (e.g., via MBSR 2210). The BS 2220 selects an AMF (e.g., AMF 2250) to serve UE 2200. The BS 2220 sends, to AMF 2250, a message (e.g., an initial UE message). The wireless device message (e.g., an initial UE message) may comprise MBSR information. The MBSR information may comprise a tracking area of a UE that uses the MBSR 2210 (e.g., UE 2200), a tracking area of MBSR 2210, an indicator and/or identifier of MBSR 2210, and/or an indicator and/or identifier of the AMF that serves MBSR 2210 (e.g., AMF 2260).

The AMF 2250 may obtain, from UDM/PCF 2290 (e.g., a UDM), subscription information associated with UE 2200. The AMF 2250 may obtain, from UDM/PCF 2290 (e.g., a PCF), policy information associated with UE 2200.

The AMF 2250 may determine to subscribe to a mobility event (e.g., an MBSR mobility event). The determining to subscribe may be based on, for example, the MBSR information received from BS 2220. The determining to subscribe may be based on, for example, the subscription and/or policy information receives from UDM/PCF 2290. Based on determining to subscribe, AMF 2250 sends a subscription to the AMF that serves the MBSR 2210 (e.g., AMF 2260). (As will be discussed in greater detail below, the figure illustrates two examples of MBSR mobility event determination, 2270 and 2280, either or both of which may be used for determination, detection, identification, and/or notification of a mobility event (e.g., as in 2104)).

After receiving the wireless device message, AMF 2250 may send an initial context setup message to BS 2220. The BS 2220 may send an RRC message to UE 2200. The RRC message may be sent via MBSR 2210. The RRC message may be a registration response (e.g., registration accept or registration reject).

MBSR mobility event determination 2270 comprises a mechanism for AMF 2250 to be notified of an MBSR mobility event. According to MBSR mobility event determination 2270, AMF 2250 sends, to AMF 2260, an event subscription 2271. The event subscription 2271 may indicate a mobility event (e.g., an MBSR mobility event, an MBSR mobility event of MBSR 2210, etc.). The event subscription 2271 may indicate for AMF 2260 to notify AMF 2250 if the mobility event is determined, detected, identified, and/or notified. The event subscription 2271 may comprise an identifier of the UE 2200, an identifier of MBSR 2210, and/or an identifier of the AMF 2250. The AMF 2260 may store, keep, maintain, and/or retain in storage the identifier of UE 2200, identifier of MBSR 2210, and/or the identifier of AMF 2250. According to MBSR mobility event determination 2270, the mobility event may be a handover determination (e.g., triggering) of the MBSR 2210.

MBSR 2210 may move into a coverage area of BS 2230. MBSR 2210 may trigger handover to BS 2230 (e.g., from BS 2220 to BS 2230). Based on triggering of handover by MBSR 2210, BS 2220 may send an N2 message 2272 to the AMF that serves MBSR 2210 (e.g., AMF 2260). The N2 message 2272 may indicate triggering of handover, an indication of area change, an indication of tracking area change, etc.

AMF 2260 may determine, detect, identify, and/or be notified of the mobility event. The determining, detecting, identifying, and/or being notified may be based on receiving the N2 message 2272. Based on determining, detecting, identifying, and/or being notified of the mobility event, AMF 2260 may notify subscribers of the mobility event (e.g., AMF 2250). Based on determining, detecting, identifying, and/or being notified of the mobility event, AMF 2260 may send, to AMF 2250 an event notification 2273. The event notification 2273 may indicate that the subscribed mobility event has occurred. Based on the event notification 2273, AMF 2250 is notified of the mobility event.

MBSR mobility event determination 2280 comprises a mechanism for AMF 2250 to be notified of an MBSR mobility event. According to MBSR mobility event determination 2280, AMF 2250 sends, to AMF 2260, an event subscription 2281. The event subscription 2281 may indicate a mobility event (e.g., an MBSR mobility event, an MBSR mobility event of MBSR 2210, etc.). The event subscription 2281 may indicate for AMF 2260 to notify AMF 2250 if the mobility event is determined, detected, and/or identified. The event subscription 2281 may comprise an identifier of UE 2200, an identifier of MBSR 2210, and/or an identifier of AMF 2250. The AMF 2260 may store, keep, maintain, and/or retain in storage the identifier of UE 2200, identifier of MBSR 2210, and/or the identifier of AMF 2250. According to MBSR mobility event determination 2280, the mobility event may be a handover of the MBSR 2210.

MBSR 2210 may move into a coverage area of BS 2230. MBSR 2210 may hand over to BS 2230 (e.g., from BS 2220 to BS 2230). Based on handover by MBSR 2210, BS 2220 may send an N2 message 2282 to the AMF that serves MBSR 2210 (e.g., AMF 2260). The N2 message 2282 may indicate a path switch, an indication of area change, an indication of tracking area change, etc.

AMF 2260 may determine, detect, identify, and/or be notified of the mobility event. The determining, detecting, identifying, and/or being notified may be based on receiving the N2 message 2282. Based on determining, detecting, identifying, and/or being notified of the mobility event, AMF 2260 may notify subscribers of the mobility event (e.g., AMF 2250). Based on determining, detecting, identifying, and/or being notified of the mobility event, AMF 2260 may send, to AMF 2250 an event notification 2283. The event notification 2283 may indicate that the subscribed mobility event has occurred. Based on the event notification 2283, AMF 2250 is notified of the mobility event.

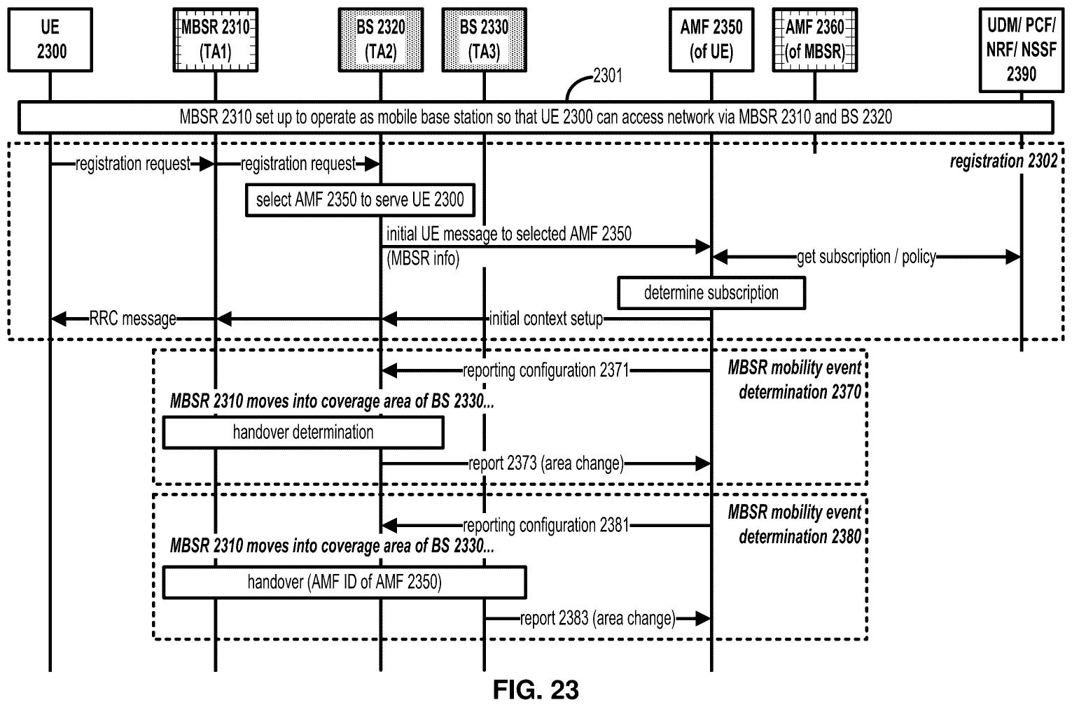

FIG. 23 illustrates examples of determination, detection, identification, and/or notification of a mobility event. For illustration purposes, the figure includes a UE 2300, an MBSR 2310, a BS 2320, a BS 2330, an AMF 2350 (serving UE 2300), an AMF 2360 (serving MBSR 2310) and a UDM/PCF/NRF/NSSF 2390. These elements may be similar to the elements illustrated in previous figures; for brevity, redundant details will be omitted.

At 2301 in the figure, similar to the previous figures, MBSR 2310 is set up to operate as a mobile base station so that UE 2300 can access the network via MBSR 2310 and BS 2320. For brevity, redundant details will be omitted.

At 2302 in the figure, similar to the previous figures, UE 2300 registers with the network. For brevity, redundant details will be omitted.

As will be discussed in greater detail below, the figure illustrates two examples of MBSR mobility event determination, 2370 and 2380, either or both of which may be used for determination, detection, identification, and/or notification of a mobility event (e.g., as in 2104).

MBSR mobility event determination 2370 comprises a mechanism for AMF 2350 to be notified of an MBSR mobility event. According to MBSR mobility event determination 2370, AMF 2350 sends, to BS 2320, a reporting configuration 2371. The reporting configuration 2371 may be an event subscription. The reporting configuration 2371 may be included in an N2 message. The reporting configuration 2371 may indicate a mobility event (e.g., an MBSR mobility event, an MBSR mobility event of MBSR 2310, an area change of MBSR 2310, an indication of tracking area change of MBSR 2310, etc.). The reporting configuration 2371 may indicate for BS 2320 to notify AMF 2350 if the mobility event is determined, detected, identified, and/or notified. According to MBSR mobility event determination 2370, the mobility event is a handover triggering of the MBSR 2310. The handover triggering may be associated with the mobility event (e.g., may be associated with an area change of MBSR 2310). The reporting configuration 2371 may comprise an identifier of AMF 2350, an identifier of MBSR 2310, etc.

MBSR 2310 may move into a coverage area of BS 2330. MBSR 2310 may trigger handover to BS 2330 (e.g., from BS 2320 to BS 2330).

BS 2320 may determine, detect, identify, and/or be notified of the mobility event. The determining, detecting, identifying, and/or notifying may be based on the handover triggering of the MBSR 2310. Based on determining, detecting, identifying, and/or notifying the mobility event, BS 2320 may notify AMF 2350 of the mobility event (e.g., a subscriber to the mobility event). Based on triggering of handover by MBSR 2310, BS 2320 may send a report 2373 to the AMF that serves UE 2300 (e.g., AMF 2350). The report 2373 may be an event notification. The report 2373 may comprise an indication of area change, an indication of tracking area change, etc. The report 2373 may be sent in an NG update message. Based on the report 2373, AMF 2350 is notified of the mobility event.

In an example, BS 2320 stores, keeps, maintains, and/or retains in storage an identifier of UE 2300 and an identifier of AMF 2350 at least until AMF 2350 is notified of the mobility event. Enhanced mechanisms for maintaining and/or releasing one or more AMF identifiers are described later in the present application.

MBSR mobility event determination 2380 comprises a mechanism for AMF 2350 to be notified of an MBSR mobility event. According to MBSR mobility event determination 2380, AMF 2350 sends, to BS 2320, a reporting configuration 2381. The reporting configuration 2371 may be an event subscription. The reporting configuration 2381 may be included in an N2 message. The reporting configuration 2381 may indicate a mobility event (e.g., an MBSR mobility event, an MBSR mobility event of MBSR 2310, an area change of MBSR 2310, an indication of tracking area change of MBSR 2310, etc.). The reporting configuration 2381 may indicate for BS 2320 or BS2330 to notify AMF 2350 if the mobility event is determined, detected, and/or identified. According to MBSR mobility event determination 2380, the mobility event is a handover of the MBSR 2310. The handover may be associated with the mobility event (e.g., may be associated with an area change of MBSR 2310). The reporting configuration 2381 may comprise an identifier of AMF 2350, an identifier of MBSR 2310, etc.

MBSR 2310 may move into a coverage area of BS 2330. MBSR 2310 may hand over to BS 2330 (e.g., from BS 2320 to BS 2330). Handover may comprise, for example, sending, by BS 2320 to BS 2330, one or more AMF identifiers (e.g., an identifier of AMF 2350). Handover may comprise, for example, sending, by BS 2320 to BS 2330, the reporting configuration 2381. The AMF list may be managed by the BS 2320. The AMF list and/or reporting configuration may be sent to BS 2330 in an Xn message.

In an example, BS 2320 stores, keeps, maintains, and/or retains in storage an identifier of UE 2300 and an identifier of AMF 2350 at least until handover to BS 2330 is performed. Enhanced mechanisms for maintaining and/or releasing one or more AMF identifiers are described later in the present application.

BS 2330 may determine, detect, identify, and/or notify of the mobility event. The determining, detecting, identifying, and/or notifying may be based on the handover of the MBSR 2310. Based on determining, detecting, identifying, and/or notifying the mobility event, BS 2330 may notify AMF 2350 of the mobility event (e.g., a subscriber to the mobility event). Based on handover of MBSR 2310, BS 2330 may send an event notification 2383 to the AMF that serves UE 2300 (e.g., AMF 2350). Based on handover of MBSR 2310, BS 2330 may send an event notification 2383 to one or more AMFs on an AMF list received from BS 2320 during handover (e.g., AMF 2350). The report 2383 may be an event notification. The report 2383 may comprise an indication of area change, an indication of tracking area change, etc. The report 2383 may be sent in an NG update message. Based on the report 2383, AMF 2350 is notified of the mobility event.

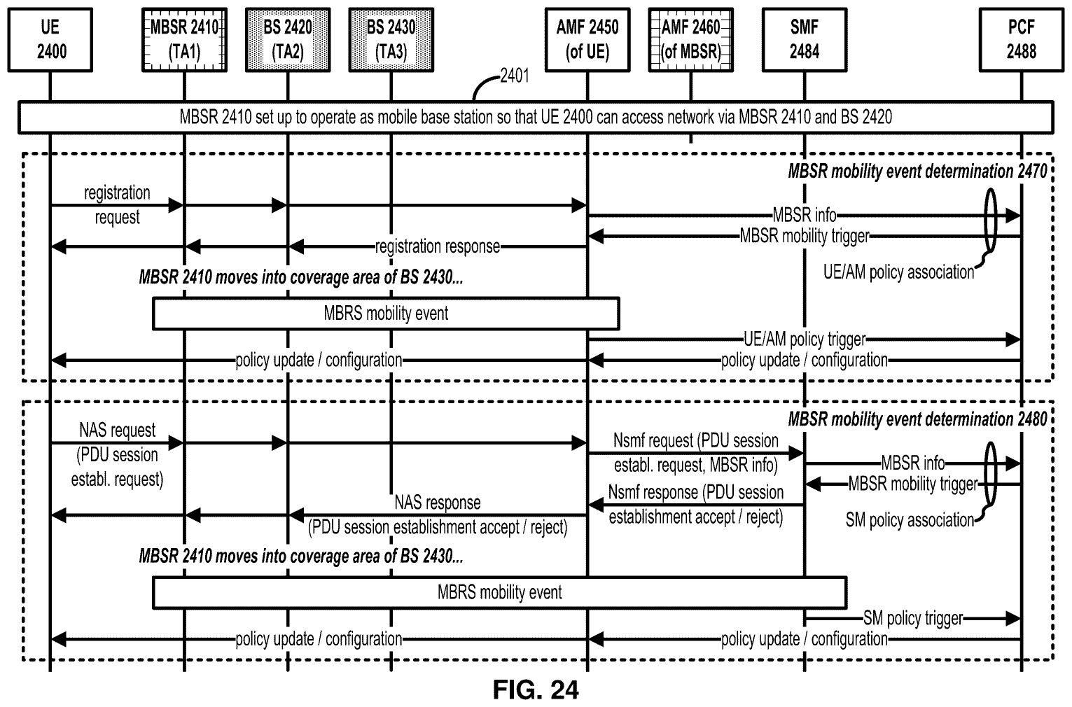

FIG. 24 illustrates examples of MBSR mobility in accordance with aspects of the disclosure. For illustration purposes, the figure includes a UE 2400, an MBSR 2410, a BS 2420, a BS 2430, an AMF 2450 (serving UE 2400), and an AMF 2460 (serving MBSR 2410). These elements may be similar to the elements illustrated in previous figures; for brevity, redundant details will be omitted. The figure includes an SMF 2484 and a PCF 2488.

At 2401 in the figure, similar to the previous figures, MBSR 2410 is set up to operate as a mobile base station so that UE 2400 can access the network via MBSR 2410 and BS 2420. For brevity, redundant details will be omitted.

In the figure, two mechanisms for mobility event determination are illustrated, 2470 and 2480, either or both of which may be used for determination, detection, identification, and/or notification of a mobility event (e.g., as in 2104).

MBSR mobility event determination 2470 comprises a mechanism for PCF 2488 to be notified of an MBSR mobility event. UE 2400 sends a registration request to BS 2420. The registration request may be sent via MBSR 2410. The BS 2420 may select an AMF to serve UE 2400. The BS 2420 sends, to the AMF (e.g., AMF 2450), the registration request.

The AMF 2450 performs a user equipment access management (UE/AM) policy association. The UE/AM policy association may be based on receiving the registration request. The AMF 2450 may send MBSR information to PCF 2488. The MBSR information may comprise a tracking area of UE 2400, a tracking area of MBSR 2410, an indicator and/or identifier of MBSR 2410, and/or use of a MBSR, and/or an indicator and/or identifier of the AMF that serves MBSR 2410 (e.g., AMF 2460). Based on receiving the MBSR information, PCF 2488 may send an MBSR policy trigger to AMF 2450. The MBSR policy trigger may indicate for AMF 2450 to notify PCF 2488 if a mobility event is determined, detected, identified, and/or notified (e.g., an MBSR mobility event, an MBSR mobility event of MBSR 2310, etc.).

The AMF 2450 sends a registration response to UE 2400. The registration request may be sent via BS 2420 and/or MBSR 2410.

MBSR 2410 may move into a coverage area of BS 2430. MBSR 2410 may determine to hand over (e.g., trigger handover) to BS 2430 (e.g., from BS 2420 to BS 2430). Additionally or alternatively, MBSR 2410 may hand over to BS 2430 (e.g., send handover request to BS 2430, receive handover accept from BS 2430, send handover command to UE 2400, complete handover, etc.). The determining to hand over and/or the handover may be determined as a mobility event.

The AMF 2450 may be notified of the mobility event. For example, AMF 2450 may be notified of the mobility event using the mechanism described in the previous figures. Based on the mobility event, AMF 2450 may send a UE/AM policy trigger to PCF 2488. The sending of the UE/AM policy trigger may be based on the MBSR mobility trigger received from PCF 2488 during UE/AM policy association.

Based on receiving the UE/AM policy trigger, PCF 2488 may perform a policy update and/or policy configuration. Based on receiving the UE/AM policy trigger, PCF 2488 may send the policy update and/or policy configuration to UE 2400, and/or AMF 2450. The policy update and/or policy configuration may be sent via AMF 2450, a base station serving the MBSR 2410 (e.g., BS 2420 and/or BS 2430), and MBSR 2410. For example, PCF 2488 may indicate to UE 2400 a policy information (e.g., UE route selection rule (URSP)). For example, the policy information may comprise a traffic descriptor, a network selection policy, a route selection descriptor. The traffic descriptor may indicate a characteristic (e.g., IP address, application name) of a traffic for which the network slice selection policy and/or the route selection descriptor applies. The network slice selection policy may indicate which network slice is used for the traffic matching the traffic descriptor. The route selection descriptor may comprise a data network name (DNN), and/or an access type used for the traffic matching the traffic descriptor. For example, PCF 2488 may indicate to the AMF 2450, new UE/AM policy information. The UE/AM policy information may comprise a RAT frequency selection policy (RFSP). The RFSP may indicate one or more list of prioritized RAT and/or frequency used for the UE.

MBSR mobility event determination 2480 comprises a mechanism for PCF 2488 to be notified of an MBSR mobility event. UE 2400 sends a NAS request to AMF 2450. The NAS request may be a PDU session establishment request. The NAS request may be sent via MBSR 2410 and BS 2420.

AMF 2450 sends an Nsmf request to SMF 2484. The sending the Nsmf request may be based on receiving the NAS request. The Nsmf request may comprise the PDU session establishment request. The Nsmf request may comprise MBSR information. The MBSR information may comprise a tracking area of a UE that uses the MBSR 2410 (e.g., UE 2400), a tracking area of MBSR 2410, an indicator and/or identifier of MBSR 2410, a use of a MBSR, and/or an indicator and/or identifier of the AMF that serves MBSR 2410 (e.g., AMF 2460).

The SMF 2484 performs a session management (SM) policy association. The SM policy association may be based on receiving the Nsmf request. The SMF 2484 may send the MBSR information to PCF 2488. Based on receiving the MBSR information, PCF 2488 may send an MBSR policy trigger to SMF 2484. The MBSR policy trigger may indicate for SMF 2484 to notify PCF 2488 if a mobility event is determined, detected, identified, and/or notified (e.g., an MBSR mobility event, an MBSR mobility event of MBSR 2310, etc.).

The SMF 2484 sends an Nsmf response to AMF 2450. The Nsmf response may comprise a PDU session establishment response. The PDU session establishment response may comprise a PDU session establishment accept or reject. The AMF 2450 sends a NAS response to BS 2420. The NAS response may be sent via BS 2420 and/or MBSR 2410.

MBSR 2410 may move into a coverage area of BS 2430. MBSR 2410 may determine to hand over (e.g., trigger handover) to BS 2430 (e.g., from BS 2420 to BS 2430). Additionally or alternatively, MBSR 2410 may hand over to BS 2430 (e.g., send handover request to BS 2430, receive handover accept from BS 2430, send handover command to UE 2400, complete handover, etc.). The determining to hand over and/or the handover may be determined as a mobility event.

The SMF 2484 may be notified of the mobility event. For example, as described above, AMF 2450 may be notified of the mobility event. Based on the notified mobility event, the AMF may determine to notify the mobility event to SMF 2484. Based on the mobility event, SMF 2484 may send an SM policy trigger to PCF 2488. The sending of the SM policy trigger may be based on the MBSR mobility trigger received from PCF 2488 during SM policy association.

Based on receiving the SM policy trigger, PCF 2488 may perform a policy update and/or policy configuration. Based on receiving the SM policy trigger, PCF 2488 may send the policy update and/or policy configuration to UE 2400, and/or to SMF 2484. The policy update and/or policy configuration may be sent via AMF 2450, a base station serving the MBSR 2410 (e.g., BS 2420 and/or BS 2430), and MBSR 2410. For example, PCF 2488 may indicate to SMF 2484 a policy and charging control rule (PCC rule). The PCC rule may comprise QoS parameter (e.g., 5GS QoS indicator (5QI), priority, data rate) to be applied for a PDU session of the UE.

Some of the foregoing figures (e.g., FIGS. 18-24) refer to AMF selection. For example, BS 2420 receives a registration request from UE 2400 via MBSR 2410. The BS 2420 selects an AMF to serve UE 2400 (e.g., AMF 2450). The BS 2420 sends the registration request to the selected AMF (e.g., AMF 2450). A similar AMF selection may occur in other figures (e.g., FIGS. 18-23).

As will be discussed in greater detail below, the presence of the MBSR may impact AMF selection. Enhanced mechanisms for facilitating AMF selection are disclosed.

Some AMFs may not support MBSR because the AMFs have not been updated to support the MBSR. For example, depending on operatory's deployment plan, some AMF may be upgraded to support MBSR, and some AMFs may be upgraded to support other functionality (e.g., multimedia broadcast). Accordingly, if BS 2420 (or BS 2420, or BS 2320, etc.) selects an AMF that does not support MBSR, issues will arise. For example, the registration request of the UE 2400 may be rejected and/or delayed. A new/different AMF may be selected. And yet the same issue may arise again if there is no mechanism for AMF selection that considers MBSR support.

In an example, a network may associate a network slice with MBSR. For example, UE 2400 may receive an indication (e.g., MBSR information and/or MBSR slice information) that a particular network slice is associated with MBSR. The particular network slice may be identified using a network slice identifier (e.g., S-NSSAI). The UE 2400 may determine to access the network via an MBSR. For example, UE 2400 may receive a SIB indicating that the UE 2400 is camping on a cell of an MBSR. Based on determining to access the network via an MBSR, UE 2400 may request the particular network slice associated with MBSR. The request for the particular network slice may comprise the identifier of the slice. For example, UE 2400 may use stored USRP. For example, the stored USRP may comprise a specific network slice identifier to be used with MBSR. For example, based on that UE 2400 access the network via the MBSR, UE 2400 may determine to use the specific network slice identifier. The request may be included in an RRC message, RRC message, RRC setup complete message, etc. The BS 2420 may receive the request for the particular network slice. The BS 2420 may select an AMF that supports the network slice (e.g., an AMF that supports the slice associated with MBSR, and therefore supports MBSR).

The UE 2400 may receive the indication of the MBSR/slice association in any suitable manner. For example, UE 2400 may receive a configuration update message. The configuration update message may be a UE configuration update message. The configuration update message may comprise a user equipment route selection policy (URSP). The configuration update message may comprise a configuration for using MBSR for network access. The configuration update message may be received from an AMF. In an example, a third party may facilitate the configuration. For example, a third party application function (AF) may access the network via a network exposure function (NEF). The AF may request that one or more wireless devices be authorized to access the network via MBSR. The AF may identify the one or more UEs (e.g., using an appropriate UE identifier). The AF may identify one or more locations of the one or more UEs. The core network function (e.g., UDM, PCF, NRF, NSSF, etc.) may grant the authorization request. The core network function may send, to the AMF (e.g., an AMF serving UE 2400), a configuration for MBSR use and/or a tracking area. The configuration for MBSR use and/or tracking area may be sent to the AMF in a Namf service request. The sending of the configuration update message, by the AMF, may be based on the receiving of the configuration for MBSR use and/or tracking area.

In an example, AMFs may register with a network repository function (NRF) and/or network slice selection function (NSSF). A first AMF may support MBSR and a second AMF may not support MBSR. The first AMF may register with the NRF and/or NSSF indicating that the first AMF supports MBSR and/or supports a network slice associated with MBSR. The second AMF may register with the NRF and/or NSSF indicating that the second AMF does not support MBSR and/or does not support a network slice associated with MBSR. The second AMF may receive a NAS request (e.g., registration request) indicating MBSR. Based on the second AMF not supporting MBSR, the second AMF may query the NRF and/or NSSF. The query may indicate an AMF that supports MBSR. Based on the query, the second AMF may receive a query response from the NRF and/or NSSF indicating the first AMF (e.g., that the first AMF supports MBSR). Based on the query response, the second AMF may forward the NAS request to the first AMF. The first AMF may send a NAS response (e.g., registration accept) to UE 2400.

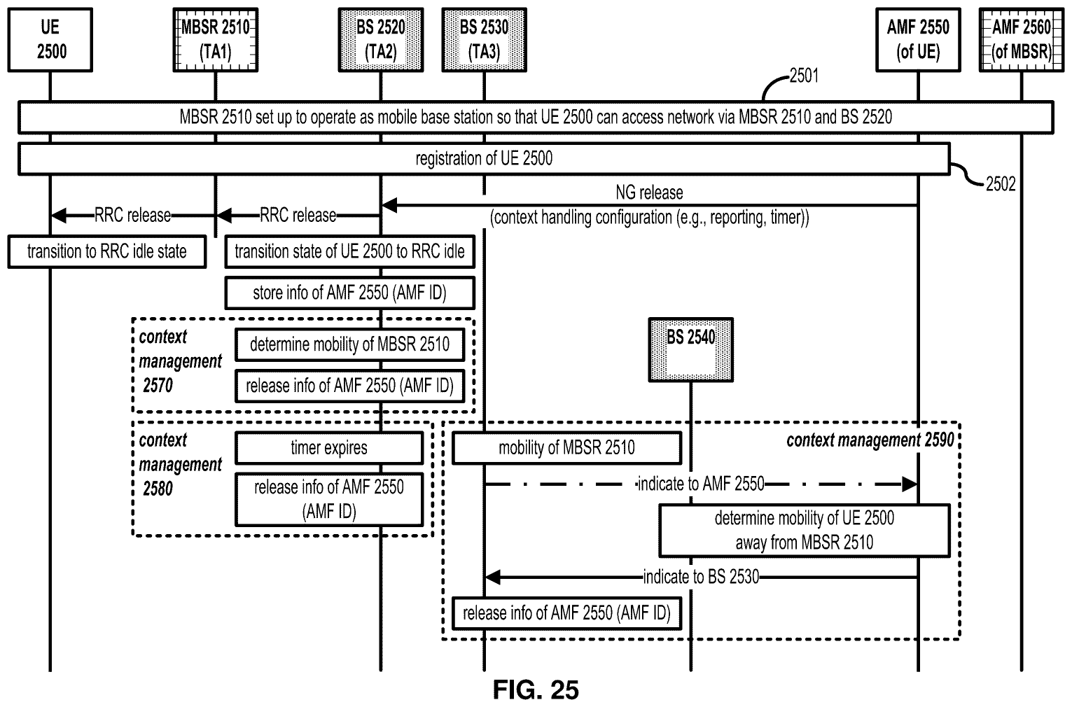

FIG. 25 illustrates examples of context management in an MBSR scenario. For illustration purposes, the figure includes a UE 2500, an MBSR 2510, a BS 2520, a BS 2530, an AMF 2550 (serving UE 2500), and an AMF 2560 (serving MBSR 2510). These elements may be similar to the elements illustrated in previous figures; for brevity, redundant details will be omitted. The figure includes a BS 2540.

At 2501 in the figure, similar to the previous figures, MBSR 2510 is set up to operate as a mobile base station so that UE 2500 can access the network via MBSR 2510 and BS 2520. For brevity, redundant details will be omitted.

At 2502 in the figure, similar to the previous figures, UE 2500 registers with the network. For brevity, redundant details will be omitted. It will be understood that during the registration of UE 2500, BS 2520 may select an AMF to serve UE 2500 (e.g., AMF 2550). It will be understood that BS 2520 may store, keep, maintain, and/or retain in storage an identifier of UE 2500 and/or an identifier of the selected AMF (e.g., an identifier of AMF 2550).

In the figure, AMF 2550 sends message to BS 2520 (and/or a CU functionality of BS 2520). In the example illustration, the message is an NG release (e.g., UE Context Release Command) message. The NG release may comprise a reporting configuration (e.g., analogous to the reporting configuration 2471 described previously). The NG release may comprise a timer configuration (e.g., a timer value). The reporting configuration and/or timer configuration may be included in a context handling configuration. The NG release may comprise a command to release UE 2500.

The BS 2520 sends an RRC release to UE 2500 (e.g., via MBSR 2510). The sending of the RRC release may be based on the receiving the NG release.

Based on the sending of the RRC release message to UE 2500, BS 2520 may transition a state of UE 2500 to an RRC idle state.

In existing technologies, BS 2520 would release a context of the UE 2500 based on the transitioning of UE 2500 to RRC idle state. The context of the UE 2500 may include the identifier of the AMF serving the UE 2500 (e.g., AMF 2550, which may be selected by BS 2520). Accordingly, after UE 2500 transitions to RRC idle state, BS 2520 would no longer have knowledge of the identifier of AMF 2550.

In some scenarios, for example, the MBSR scenario illustrated in FIGS. 19-24, release of the context of the UE 2500 may cause problems. For example, as described previously, FIG. 24 illustrates an example MBSR mobility event determination 2470, wherein the BS 2420 reports mobility of MBSR 2410 to the AMF serving the UE 2500 (AMF 2450). Similar reporting may enable AMF 2550 to determine, detect, identify, and/or be notified that a mobility event has occurred; potentially prompting UE 2500 to perform a NAS procedure (for example, as described previously with respect to FIG. 21). However, if the context of UE 2500 has been released (e.g., due to transition of UE 2500 to an RRC idle state), then BS 2420 may not know the AMF ID of AMF 2550, and may not be able to report mobility of MBSR 2510 to AMF 2550.

In accordance with aspects of the disclosure, context management may comprise storing, keeping, maintaining, and/or retaining in storage: an identifier of a UE (e.g., UE 2500) that uses an MBSR (e.g., MBSR 2510) to access a network; and/or an identifier of an AMF (e.g., AMF 2550) associated with the UE. The storing, keeping, maintaining, and/or retaining in storage may be performed after UE 2500 is transitioned to an RRC idle state and/or after a context of the UE is released. As an example, the context of UE 2500 may be released, but the identifier of UE 2500 and/or the identifier of AMF 2550 may be stored, kept, maintained, and/or retained in storage. Additionally or alternatively, a first partial context of UE 2500 may be released (e.g., a part of the context that does not comprise the identifier of UE 2500 and/or the identifier of AMF 2550), and a second partial context of UE 2500 may not be released (e.g., a part of the context that comprises the identifier of UE 2500 and/or the identifier of AMF 2550). Additionally or alternatively, when the UE access the network via the MBSR, the identifier of the AMF (e.g., AMF 2550) may be added to the context of the MBSR.

In accordance with aspects of the disclosure, context management may comprise sending, by the BS 2520 to the BS 2530, the identifier of UE 2500 and/or the identifier of AMF 2550 (e.g., the second partial context). The sending of the identifier of UE 2500 and/or the identifier of AMF 2550 may be based on handing over of MBSR 2510 from BS 2520 to BS 2530. The sending of the identifier of UE 2500 and/or the identifier of AMF 2550 may enable the new parent node BS 2530 of MBSR 2510 to take over the role of BS 2520 going forward (e.g., notify AMF 2550 of future MBSR mobility events). Additionally, based on the identifier of AMF 2550, the BS 2530 may indicate the mobility event (e.g., mobility of the MBSR, change of an area) to AMF 2550.

In addition to sending the identifier of UE 2500 and/or the identifier of AMF 2550 to BS 2530, BS 2520 may send the context handling configuration, reporting configuration, and/or timer configuration referred to above and/or described in greater detail below.

In existing technologies, one purpose of context release is to clear storage resources within, for example, a base station and/or base station central unit. For example, once a UE has transitioned to an RRC idle state, there is a reduced likelihood that the context of the UE continues to be useful. For example, the UE may move to a different coverage area, in which case it makes little sense to retain any information about the UE's connection. In such a case, with potentially thousands of UEs moving through a coverage area of a base station and/or base station central unit, UE contexts for every UE cannot be retained.

In accordance with aspects of the disclosure, context management may comprise releasing: an identifier of a UE (e.g., UE 2500) that uses an MBSR (e.g., MBSR 2510) to access a network; and/or an identifier of an AMF (e.g., AMF 2550) associated with the UE. As noted above, existing techniques may release this information (e.g., a context of the UE) upon release of the UE and/or transition of the UE to an RRC idle state. As further noted above, there may be reasons to store, keep, maintain, and/or retain this information beyond the release of the UE and/or transition of the UE to the RRC idle state. However, it may be disadvantageous to retain this information indefinitely. For example, not every UE accesses the network via MBSR, but it still may be a large number of UEs that do so. Accordingly, there may be benefits to the introduction of some new mechanism for releasing this information.

In the figure, three mechanisms for context management are illustrated, 2570, 2580, and 2590, any or all of which may be used for context management by BS 2520, BS 2530, or both.

According to the mechanism for context management 2570, the BS 2520 determines mobility of the MBSR 2510. For example, BS 2520 may hand MBSR 2510 over to BS 2530. In such a case, the reasons for continuing to store the identifier of UE 2500 and/or the identifier of AMF 2550 cease to apply. Accordingly, BS 2520 may release the identifier of UE 2500 and/or the identifier of AMF 2550. For example, BS 2520 may release the (full) context of UE 2500 which would (in the case of existing technologies) have otherwise been performed immediately upon transition of UE 2500 to RRC idle state.

According to the mechanism for context management 2580, the BS 2520 determines that a timer expires. For example, the timer and/or a timer value of the timer may be indicated by AMF 2550 in the NG release illustrated in FIG. 25. Alternatively, the timer may be a preconfigured timer with a timer value known in advance by the BS 2520, or the timer value of the timer may be configured in the context for the MBSR. The timer may be started upon transition of UE 2500 to RRC idle state. BS 2520 may continue to store the identifier of UE 2500 and/or the identifier of AMF 2550 for as long as the timer is running. Upon expiration of the timer, BS 2520 may release the (full) context of UE 2500 which would (in the case of existing technologies) have otherwise been performed immediately upon transition of UE 2500 to RRC idle state.

According to the mechanism for context management 2590, the BS 2530 determines mobility of the MBSR 2510. For example, BS 2520 may hand MBSR 2510 over to BS 2530. BS 2530 may receive (e.g., as part of the handover (e.g., in a handover request message)) the identifier of UE 2500 and/or the identifier of AMF 2550 (e.g., a partial context of UE 2500).

The BS 2530 may send an indication to AMF 2550. The BS 2530 may use the identifier of AMF 2550 received from BS 2520 to identify AMF 2550. The indication to AMF 2550 may indicate that MBSR 2510 has been handed over to BS 2530; for example, the indication to AMF 2550 may comprise an identifier of MBSR 2510 and/or an identifier of BS 2530. Additionally or alternatively, the indication to AMF 2550 indicates that BS 2530 subscribes to a notifications regarding mobility of UE 2500; for example, the indication to AMF 2550 may comprise the identifier of UE 2500 and the identifier of BS 2530. (In some scenarios, this indication is optional and need not be sent; for example, if the mechanism for MBSR mobility event determination 2470 is followed, then BS 2520 may provide the indication(s) to AMF 2550 (e.g., in the report 2473)).

The AMF 2550 may determine mobility of UE 2500 (e.g., mobility of UE 2500 away from MBSR 2510 and/or to another BS 2540). The AMF 2550 may send an indication to BS 2530. The indication to BS 2530 may indicate that UE 2500 has handed over from MBSR 2510; for example, the indication to BS 2530 may comprise an identifier of the UE 2500 and/or an indication to release the identifier of UE 2500 and/or the identifier of AMF 2550. Based on receiving the indication, BS 2530 may release the identifier of UE 2500 and/or the identifier of AMF 2550.

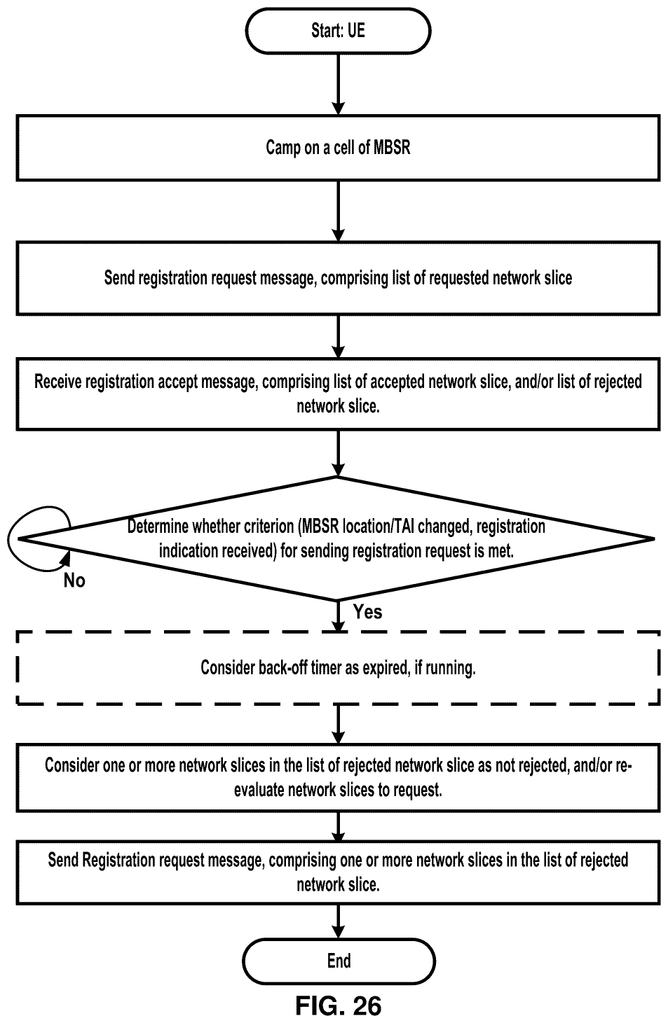

FIG. 26 illustrates an example in accordance with aspects of the disclosure.

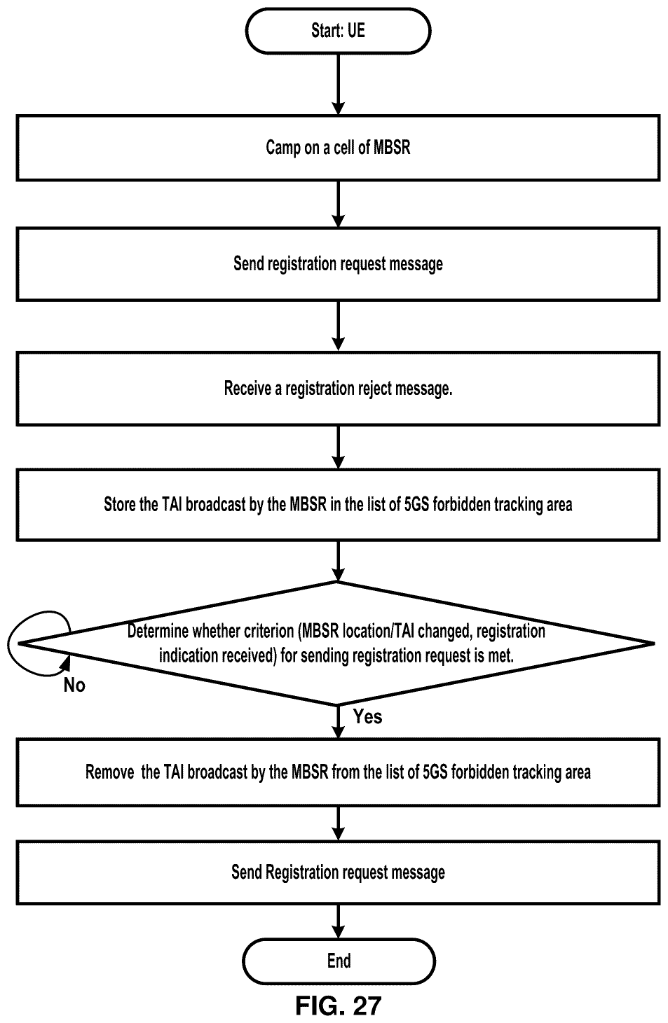

FIG. 27 illustrates an example in accordance with aspects of the disclosure.

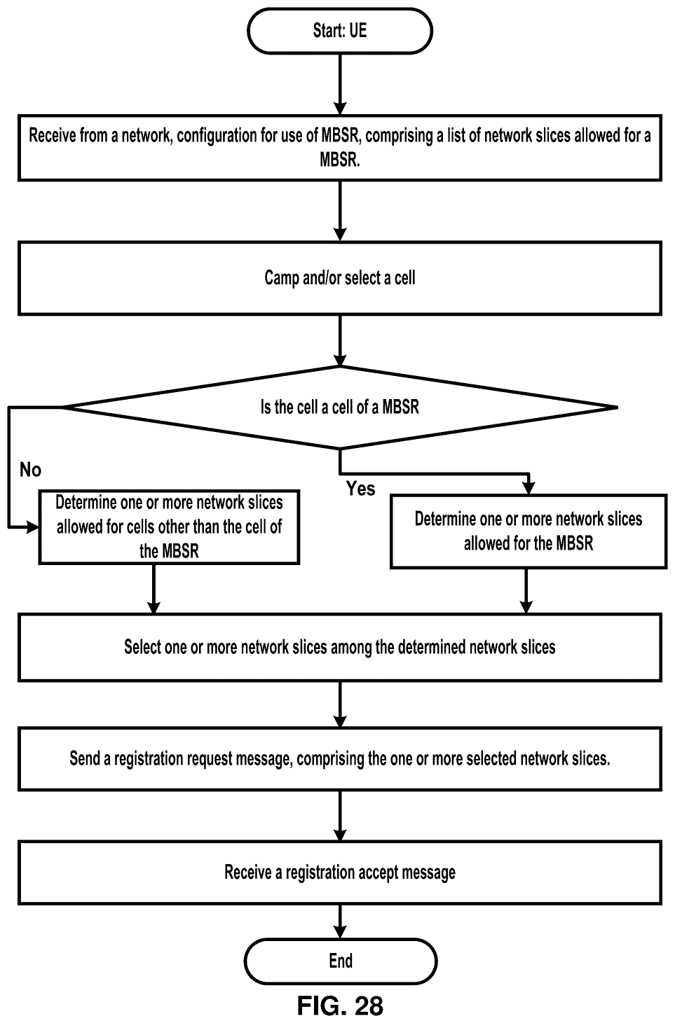

FIG. 28 illustrates an example in accordance with aspects of the disclosure.

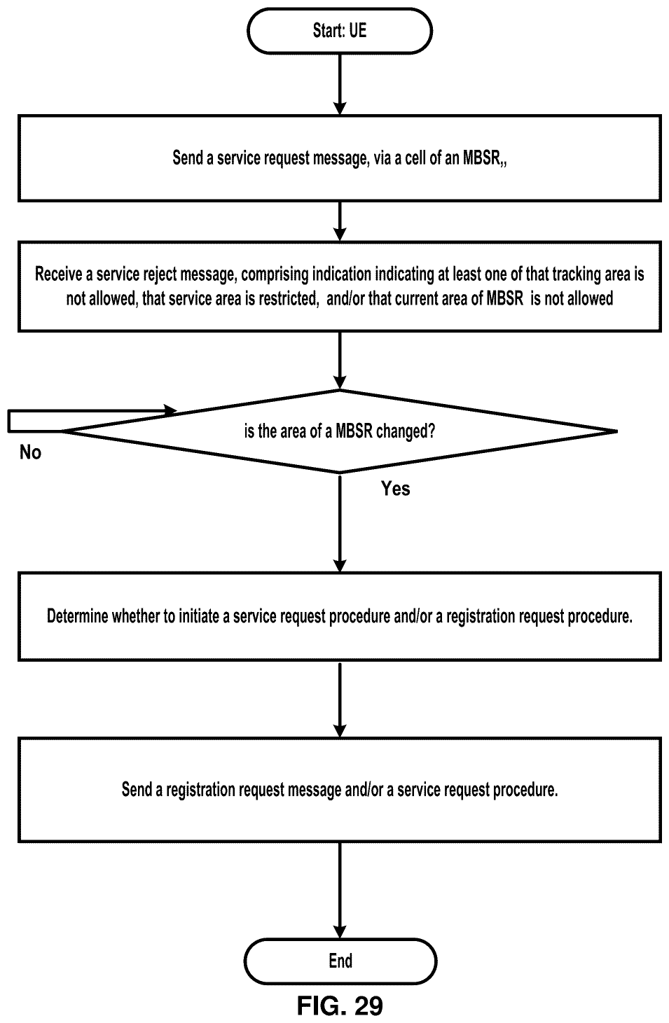

FIG. 29 illustrates an example in accordance with aspects of the disclosure.

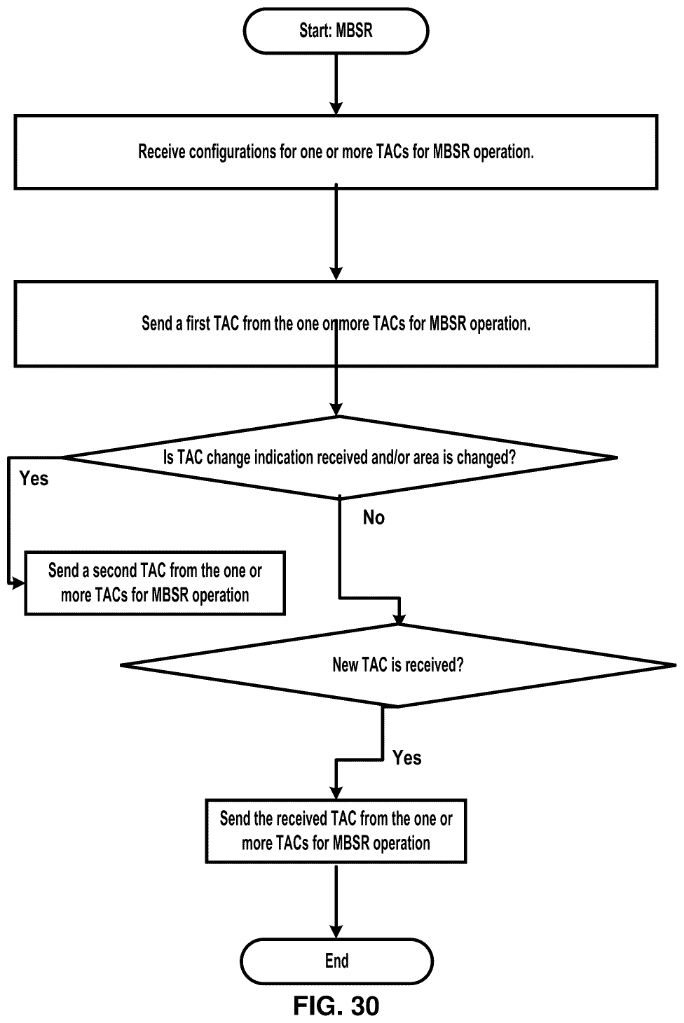

FIG. 30 illustrates an example in accordance with aspects of the disclosure.

In an example, a wireless device receives a registration response message comprising a list of rejected network slices. The wireless device receives via a first cell of an integrated access and backhaul (IAB) node, a system information block (SIB) message comprising a first tracking area code (TAC) of the first cell. The wireless device receives area information, of a second cell to which the IAB node is connected, comprising at least one of: a second TAC of the second cell; an indication indicating change of an area associated with backhaul of the IAB node; and an allow indication to perform a registration request procedure. The base station determines, based on the area information, whether to send a registration request message comprising request for one or more network slices from the list of rejected network slices. The wireless device sends, based on the determining, the registration request message.

In an example, the wireless device receives the registration response message from an AMF via a next generation radio access network (NG-RAN).

In an example, the allow indication to perform a registration request procedure is based on a change of a tracking area associated with a backhaul of the IAB-node.

In an example, an area associated with backhaul of the IAB node is identified by at least one of a second TAC, a second NG-RAN cell global identifier (NCGI), a second RAN notification area (RNA) identity, and/or a secondary TAC.

In an example, the second NCGI is a NCGI of the second cell.

In an example, the second RNA identity is an RNA identity of the second cell.

In an example, the secondary TAC is a TAC broadcast by the first cell, in addition to the first TAC.

In an example, the wireless device connects to the first cell via Uu interface.

In an example, the IAB node connects to the second cell via Uu interface.

In an example, the wireless device determines to send the registration request message, based on at least one of change from a third TAC of a third cell to the second TAC, reception of the indication indicating change of the area, and the reception of the allow indication.

In an example, the change of the area associated with backhaul of the IAB node comprises at least one of change of the area where the IAB node is located, change of a cell to which the IAB node is connected.

In an example, the change of the NG-RAN associated with the first cell comprises at least one of change of gNB-CU associated with the first cell, and handover of IAB-node of the first cell.

In an example, the area information is delivered by an RRC message, comprising at least one of a SIB message, RRC reconfiguration message, and DL information transfer message.

In an example, further comprising receiving by the wireless device, a configuration message, comprising registration configuration information.

In an example, the registration configuration information indicates whether the wireless device needs to send the registration request message, if the wireless device receives the RRC message.

In an example, the wireless device does not send the registration request message if the registration configuration information indicates not to send the registration request message.

In an example, the registration request message comprises at least one of identifier of the wireless device, information on capability of the wireless device, and list of requested network slices.

In an example, the identifier of the wireless device comprises at least one of subscriber concealed identity (SUCI), 5G-GUTI, and 5G-S-TMSI.

In an example, the information on capability of the wireless device comprises at least one of information on capability for network slice-specific authentication and authorization, and capability for closed access group.

In an example, the wireless device receives the registration response message, based on sending a first registration request message.

In an example, the first registration request message comprises information on capability for tracking area (TA) handing for mobile IAB node.

In an example, the information on capability for TA handling for mobile IAB node indicates whether the wireless device supports handling of at least one of the second TAC of the second cell, the indication indicating change of the area, and the allow indication to perform the registration request procedure.

In an example, the wireless device receives the area information, based on sending the information on capability for TA handling for mobile IAB node.

In an example, the registration response message comprises at least one of a registration accept message, and a registration reject message.

In an example, the list of rejected network slices comprises at least one of one or more identifiers of the rejected network slices, and one or more causes of rejection.

In an example, the one or more causes of rejection indicate that the one or more network slices are rejected, based on at least one of the location of the wireless device, the location of the IAB node, the second cell, the second TAC, and mobile IAB node.

In an example, the registration response message further comprises at least one of an indication of whether the wireless device is allowed to send the registration request message, and one or more conditions to send the registration request message.

In an example, the wireless device sends the registration request message if the indication indicates that the wireless device is allowed to send the registration request message.

In an example, the wireless device sends the registration request message if the one or more conditions are met.

In an example, the one or more conditions comprise at least one of: the wireless device uses mobile IAB node; and the wireless device receives the area information.

In an example, the IAB node comprises at least one of a second wireless device, a mobile base station, a mobile base station relay, a mobile NG-RAN, a mobile gNB, a mobile gNB-CU, a network node, a network device, and a mobile gNB-DU.

In an example, the IAB node provides the first cell for the wireless device.

In an example, a wireless device receives a response message rejecting a service for one or more network slices. The wireless device receives from a first cell of an integrated access and backhaul (IAB) node, an information indicating at least one of: change of area associated with the first cell; allowance of a request for the service for the one or more network slice. The wireless device sends, based on the information, a request message requesting a service for the one or more network slices.

In an example, a network device sends a radio resource control (RRC) message comprising: change of area associated with the first cell; allowance of a request for the service for the one or more network slice. The network device receives a request message requesting a service for the one or more network slices.

In an example, a network device receives, from a wireless device, a request message requesting a service for one or more requested network slices. The network device sends a response message rejecting the service for one or more rejected network slices among the one or more requested network slices. The network device stores, based on the fact that the wireless device is in a cell associated with an integrated backhaul access node, at least one of the one or more rejected network slices and the one or more requested network slices.

In an example, a first network node receives, from a base station, a message comprising:—an identifier of a wireless device; at least one of identifier for an integrated access backhaul (IAB) node and an identifier of a second network node. The first network node receives, from the second network node, a notification indicating change of area associated with the IAB node. The first network node sends, to the wireless device, an indication requesting a registration procedure.

In an example, the first network node is an AMF of the wireless device.

In an example, the second network node is an AMF of the IAB node.

In an example, a second network node receives receiving, by a second network node for an integrated access backhaul (IAB) node from a first network node, a message comprising at least one of an identifier of the first network node and an identifier of the IAB node. The second network node sends, to the first network node, a notification indicating change of area associated with the IAB node.

In an example, the first network node is an AMF of the wireless device.

In an example, the second network node is an AMF of the IAB node.

In an example, a network node sends, to a NG-RAN for an integrated access backhaul (IAB) node, a message comprising requesting change of area of the IAB node. The network node receives, from the NG-RAN, a notification indicating change of area associated with the IAB node.

In an example, the network node is an AMF of the UE.

In an example, a network node receives, from a policy control function (PCF), a policy control request trigger (PCRT) for a wireless device. The network node determines a change of area of the IAB node serving the wireless device. The network node sends, to the PCF, a notification indicating the change of area of the IAB node.

In an example the notification is an Npcf_AMpolicyControl_Update.

In an example, a third network node receives, from a base station, a request message comprising at least one of: an identifier for a wireless device; at least one of identifier of an integrated access backhaul (IAB) node for the wireless device; and an indication of IAB-node. The third network node sends, to a fifth network node (PCF), a policy request message for the wireless device comprising: an identifier for a wireless device; at least one of identifier of an integrated access backhaul (IAB) node for the wireless device; and an indication of IAB-node.

In an example, the third network node is a source AMF of the UE.

In an example, the fifth network node is a policy control function (PCF).

In an example, a first base station receives, from a network function, a request for notification for a change of area of an IAB node serving the wireless device. The first base station determines to handover the IAB node to a second base station. The first base station sends, to the second base station, an information of a network function (UE-AMF) associated with the wireless device.

In an example, the network function is an AMF of the UE.

In an example, a base station receives from a network node, for a wireless device served by a IAB node, a message comprising context handling configuration information, wherein the context handling configuration information comprises at least one of: an identifier for the wireless device; and a time period for releasing context of the network node. The base station discards and/or releases the context of the network node based on expiration of the time period.

In an example, a wireless device receives a configuration message comprising one or more network slice identifiers for a mobile integrated access backhaul (IAB) node. The wireless device sends, based on a cell of the mobile IAB node, a request message requesting a service for one or more network slices indicated by the one or more network slice identifiers.

In an example, sending, by a policy control function (PCF) to a network function repository function (NRF), a network management registration message comprising indication of whether the PCF supports mobile integrated access backhaul (IAB) node. The PCF receives, from the NRF, an indication of registration status for the PCF.

In an example, a first network node sends, to a network function repository function (NRF), a network management query message comprising indication of support of mobile integrated access backhaul (IAB) node and a policy control function (PCF). The first network node receives, from the NRF, a response message comprising one or more information of PCFs supporting mobile IAB nodes.

In an example, a first network node sends, to a network function repository function (NRF), a network management query message comprising an indication of support of a mobile integrated access backhaul (IAB) node and an access and mobility management function (AMF). The first network node receives, from the NRF, a response message comprising one or more information of AMFs supporting mobile IAB nodes.

A third network nodes sends, to a fourth network node, in an example, sending, by a third network node to a fourth network node, a request message for a context relocation comprising: an identifier for a wireless device; at least one of identifier of an integrated access backhaul (IAB) node for the wireless device; and an indication of IAB-node.

In an example, the third network node is a source AMF of the wireless device.

In an example, the fourth network node is a target AMF of the wireless device.

In an example, a fourth network node receives, from a third network node (source UE-AMF), a request message for a context relocation comprising: an identifier for a wireless device; at least one of identifier of an integrated access backhaul (IAB) node for the wireless device and an indication of IAB-node. The fourth network node sends, to the wireless device, a message allowing a registration request procedure.

In an example, the third network node is a source AMF of the wireless device.

In an example, the fourth network node is a target AMF of the wireless device.

1. A method comprising:
sending, by a first wireless device to an access and mobility management function (AMF) via a mobile base station relay (MBSR), a registration request message requesting a first network slice and a second network slice, wherein the MBSR:
comprises:
a base station distributed unit; and
a mobile terminal unit connecting to a base station central unit via a Uu interface;
supports mobility within a network; and
broadcasts an indication of a mobile relay cell;
receiving, from the MBSR, a registration accept message indicating:
the first network slice being allowed; and
the second network slice being rejected;
receiving, from the MBSR, one or more messages indicating:
a tracking area change of the MBSR; and
the second network slice being supported; and
the first network slice being rejected; and
sending, based on the one or more messages, a second registration request message indicating the second network slice.

2. The method of claim 1, wherein the wireless device is in the mobile relay cell of the MBSR.

3. The method of claim 1, wherein the tracking area change of the MBSR is due to a mobility event of the MBSR.

4. The method of claim 3, wherein the mobility event of the MBSR is movement by the MBSR from a first coverage area of a first base station to a second coverage area of a second base station.

5. The method of claim 3, wherein the AMF is configured to notify a policy and charging function (PCF) of the mobility event of the MBSR.

6. The method of claim 3, wherein the one or more messages are based on the mobility event.

7. The method of claim 1, wherein the second registration request message indicates the second network slice using a single network slice selection assistance information (S-NSSAI).

8. A first wireless device comprising one or more processors and memory storing instructions that, when executed by the one or more processors, cause the first wireless device at least to perform:
sending, to an access and mobility management function (AMF) via a mobile base station relay (MBSR), a registration request message requesting a first network slice and a second network slice, wherein the MBSR:
comprises:
a base station distributed unit; and
a mobile terminal unit connecting to a base station central unit via a Uu interface;
supports mobility within a network; and
broadcasts an indication of a mobile relay cell;
receiving, from the MBSR, a registration accept message indicating:
the first network slice being allowed; and
the second network slice being rejected;
receiving, from the MBSR, one or more messages indicating:
a tracking area change of the MBSR; and
the second network slice being supported; and
the first network slice being rejected; and
sending, based on the one or more messages, a second registration request message indicating the second network slice.

9. The first wireless device of claim 8, wherein the wireless device is in the mobile relay cell of the MBSR.

10. The first wireless device of claim 8, wherein the tracking area change of the MBSR is due to a mobility event of the MBSR.

11. The first wireless device of claim 10, wherein the mobility event of the MBSR is movement by the MBSR from a first coverage area of a first base station to a second coverage area of a second base station.

12. The first wireless device of claim 10, wherein the AMF is configured to notify a policy and charging function (PCF) of the mobility event of the MBSR.

13. The first wireless device of claim 10, wherein the one or more messages are based on the mobility event.

14. The first wireless device of claim 8, wherein the second registration request message indicates the second network slice using a single network slice selection assistance information (S-NSSAI).

15. A non-transitory computer-readable medium comprising instructions that, when executed by one or more processors of a first wireless device, cause the first wireless device to perform:
sending, to an access and mobility management function (AMF) via a mobile base station relay (MBSR), a registration request message requesting a first network slice and a second network slice, wherein the MBSR:
comprises:
a base station distributed unit; and
a mobile terminal unit connecting to a base station central unit via a Uu interface;
supports mobility within a network; and
broadcasts an indication of a mobile relay cell;
receiving, from the MBSR, a registration accept message indicating:
the first network slice being allowed; and
the second network slice being rejected;
receiving, from the MBSR, one or more messages indicating:
a tracking area change of the MBSR; and
the second network slice being supported; and
the first network slice being rejected; and
sending, based on the one or more messages, a second registration request message indicating the second network slice.

16. The non-transitory computer-readable medium of claim 15, wherein the wireless device is in the mobile relay cell of the MBSR.

17. The non-transitory computer-readable medium of claim 15, wherein the tracking area change of the MBSR is due to a mobility event of the MBSR.

18. The non-transitory computer-readable medium of claim 17, wherein the mobility event of the MBSR is movement by the MBSR from a first coverage area of a first base station to a second coverage area of a second base station.

19. The non-transitory computer-readable medium of claim 17, wherein the AMF is configured to notify a policy and charging function (PCF) of the mobility event of the MBSR.

20. The non-transitory computer-readable medium of claim 17, wherein the one or more messages are based on the mobility event.
